(19) United States
(12) Patent Application Publication
(10) Pub. No.: US 2012/0115379 A1
(43) Pub. Date: May 10, 2012

(54) MULTI-LAYERED COMPOSITE CUSHIONING MATERIAL AND METHOD FOR MAKING THE SAME

(75) Inventor: Daniel Kim, Busan (KR)

(73) Assignee: Applied FT Composite Solutions Inc., Las Vegas, NV (US)

(21) Appl. No.: 13/293,040

(22) Filed: Nov. 9, 2011

Related U.S. Application Data
(60) Provisional application No. 61/411,811, filed on Nov. 9, 2010.

(51) Int. Cl. D04G 1/00; D04H 13/00; B32B 37/12; B32B 3/26; B32B 27/00; B32B 27/40; B32B 9/04; D03D 15/00

(52) U.S. Cl. 442/1; 442/327; 442/181; 428/304.4; 428/500; 428/423.1; 156/297

(57) ABSTRACT

The present application discloses a multi-layered composite pad including at least two layers of resilient element and at least one layer of carrier substrate, wherein at least one carrier substrate layer is positioned between two adjacent resilient elements, and the carrier substrate and resilient element are bound to each other through a joining element, wherein the joining element joins the carrier substrate and its adjacent resilient element.

### BACKGROUND OF THE INVENTION

### General Background and State of the Art

The invention relates to a multi-layered composite material suitable for use as padding, or as protective or cushioning material. The invention also relates to a method of making the composite material. The composite material comprises of a sheeting structure with at least two layers of resilient elements, each of them bonded to at least one other resilient element, either directly or by means of an intermediary, or carrier substrate. Each resilient element in the sheeting structure may be of the same or different materials in relation to other resilient elements. Each resilient element in the sheeting structure may also be of the same or different thickness and dimension in relation to the other resilient elements. The composite material may be cut in a variety of shapes and sizes, and attached to or incorporated into clothing, pads, padding, or protective equipment.

### SUMMARY OF THE INVENTION

Foam materials, including polyurethane (“PU”) foams, ethylene vinyl acetate (“EVA”) foams, olefin and polyolefin foams, and other thermoplastic foams, have customarily been used in paddings, pads, and protective gear and equipment for their protective and shock absorbing characteristics.

Different types of foam materials may have different densities, hardness, stretch, or tear resistance, and may display different performance characteristics. Even the same type of foam materials may be formulated or fabricated so as to have different densities, hardness, stretch, or tear resistance characteristics.

In some instances, it may be advantageous to combine different types of materials, or same types of materials displaying different characteristics, for use in paddings, pads, protective gear and equipment, and in other similar applications. For example, in fabricating protective pads incorporating cushioning foam components, it may be advantageous in some instances to select a comparatively harder, denser, and more abrasion and puncture resistant material for the outer layer or section of the pad, and a comparative softer and stretchable material with better shock absorption characteristics for the inner layer or section.

Conventionally, composite materials that combine different types of materials, or same type of materials displaying different qualities or performance characteristics, are fabricated by gluing sheets of different types of materials together by use of adhesives, or by heating the contact surfaces of sheets of materials until the contact surfaces liquefy and bond to each other.

However, certain classes of foam materials (such as, by way of example only and without limitations, EVA, olefin, or polyolefin foams) are difficult to bond with other classes of foam materials (such as, by way of example only and without limitations, PU foams) without the use of specialized, costly, or toxic glues, or special pre-treatment of the surface of the foam materials prior to the application of the adhesive.

The alternative conventional process of gluing sheets of foam material together by heating their contact surfaces often results in uneven bonding, and may require specialized equipment and complex heating elements designed to ensure even and controlled heating of the bonding surface.

The present invention relates to various composite materials comprised of multiple layers of different types of component materials bonded together by use of a carrier substrate, and to the method of making such composite materials. In one aspect of the invention, two different bonding agents that optimally bond to different types of materials are applied or positioned over opposite sides of a carrier substrate. The carrier substrate is then “sandwiched” between two different types of materials, and the entire assembly is pressed or heat-pressed, thus binding them.

The present invention also relates to composite materials comprised of multiple layers of same or similar types of component materials bonded together, and to the method of making such composite materials. In one aspect of the invention, a heat activated bonding agent is applied to the contact surface of one or more sheets of component materials. The contact surfaces of the component materials are locally heated and pressed together, thus activating the bonding agent and ensuring uniform bonding of the surfaces of the two component materials.

In one aspect, the present invention is directed to a multi-layered composite pad including at least two layers of resilient element and at least one layer of carrier substrate, wherein at least one carrier substrate layer is positioned between two adjacent resilient elements, and the carrier substrate and resilient element are bound to each other through a joining element, wherein the joining element joins the carrier substrate and its adjacent resilient element.

The resilient element layers may be composed of material that are not capable of directly binding to each other.

Further, the composite pad may include a carrier substrate having a first and second side which is in contact with a first joining element on a first side of the carrier substrate that allows binding between a first resilient element with the first side of the carrier substrate, and

a second joining element on a second side of the carrier substrate that allows binding between a second resilient element with the second side of the carrier substrate.

In one embodiment, the first and second resilient elements may not be capable of directly binding to each other. In another embodiment, the first resilient element may be made of a composition including ethylene vinyl acetate, olefin, or polyolefin foam, sheet, or film. The second resilient element may be made of a composition including polyurethane foam, sheet, or film, or urethane based foam, sheet, or film.

In a further embodiment, the first joining element may be made of a composition including ethylene vinyl acetate, olefin, or polyolefin based glue, hot-melt adhesive film, or bonding agent. The second joining element may be made of a composition including polyurethane or urethane based glue or hot-melt adhesive film, or bonding agent.

In another aspect, the invention is directed to a composite pad that may include at least two layers of resilient element and at least two layers of carrier substrate; at least three layers of resilient element and at least two layers of carrier substrate; at least three layers of resilient element and at least three layers of carrier substrate; at least four layers of resilient element and at least three layers of carrier substrate; or at least four layers of resilient element and at least four layers of carrier substrate; and so on so long as the resilient elements and carrier substrates are able to temporarily or permanently bind to adjoining layer of resilient element or carrier substrate. Preferably, permanent bonding is desired.

The carrier substrate may be non-woven fabric, woven fabric, sheet of mesh, sheet of natural fiber, or sheet of synthetic fiber; or swatches of polyester or nylon fabric or mesh; or include one or more sheets or swatches of polyester or nylon fabric or mesh sheet, bonded to each other in one or more layers.

The resilient element may be made of ethylene vinyl acetate, olefin, or polyolefin foam, sheet, or film, polyurethane foam, sheet, or film, or urethane based foam, sheet, or film.

The joining element may be an adhesive capable of joining the carrier substrate to the adjoining resilient element. The adhesive may be made of a composition comprising ethylene vinyl acetate, olefin, or polyolefin based glue, hot-melt adhesive film, or bonding agent, or polyurethane or urethane based glue or hot-melt adhesive film, or bonding agent. In another aspect, the adhesive may be a double-sided tape with adhesive coated on both sides.

In another aspect, the resilient element or carrier substrate may be perforated. The resilient elements may have the same or different physical characteristics. Further, the composite pad may include the resilient elements and carrier substrate layers positioned in alternating order.

In another aspect, the invention is directed to a solid support that may include the composite pad described herein. The support may be, without limitation, an athletic garment, footwear, bag, backpack, sack, seating pads, or athletic equipment. An athletic safety wear is preferred.

In another aspect, the invention may be directed to a method for fabricating a multi-layered composite structure for use as a resilient cushion, including:

(i) applying or positioning first adhesive on first side of first carrier substrate or first side of first resilient element;

(ii) contacting first side of first resilient element with the first side of the carrier substrate through contact with the first adhesive;

(iii) applying pressure or heat or both to the first carrier substrate or the first resilient element to form a first laminate;

(iv) applying or positioning second adhesive on second side of first carrier substrate, the first side of second resilient element, or to both the first carrier substrate and the first resilient element;

(v) contacting first side of second resilient element with second side of first carrier substrate through contact with the second adhesive; and

(vi) applying pressure or heat or both to the first carrier substrate or the second resilient element to form second laminate.

In another aspect, the invention may be further directed to the method above further including:

(vii) applying or positioning third adhesive on first side of second carrier substrate or second side of second resilient element;

(viii) contacting second side of second resilient element with the second carrier substrate through contact with the third adhesive; and

(ix) applying pressure or heat or both to the second carrier substrate or second resilient element to form third laminate.

In yet another aspect, the invention may be further directed to the methods above further including:

(x) applying or positioning fourth adhesive on second side of second carrier substrate or first side of third resilient element;

(xi) contacting first side of third resilient element with the second side of the second carrier substrate through contact with the fourth adhesive; and

(xii) applying pressure or heat or both to the second carrier substrate or third resilient element to form fourth laminate.

In one aspect, the resilient elements may be made of materials that are not capable of binding directly to each other temporarily or permanently. For instance, without limitation, the first resilient element may include ethylene vinyl acetate, olefin, or polyolefin foam, sheet, or film. The second resilient element may include polyurethane foam, sheet, or film, or urethane based foam, sheet, or film.

In one aspect, the carrier substrate above may include a double-sided tape with adhesive coated on both sides.

In another aspect, where the first resilient element is EVA based material, the adhesive that binds to it may be made of a composition that includes ethylene vinyl acetate, olefin, or polyolefin foam, sheet, or film. In another aspect, where the second resilient element is polyurethane based material, the adhesive that binds to it may be made of a composition that includes polyurethane foam, sheet, or film, or urethane based foam, sheet, or film.

Heat or pressure or both may be applied through a roller; heat or pressure or both may be applied simultaneously to each side of the laminate; or heat may be provided separately from the pressure. Heat may be provided through such methods as using heat platen or radiofrequency.

The surface of the carrier substrate or the resilient element to be bonded to each other or both surfaces, or may be pre-heated by way of a heating element prior to the application of heat, pressure, or both.

These and other objects of the invention will be more fully understood from the following description of the invention, the referenced drawings attached hereto and the claims appended hereto.

### BRIEF DESCRIPTION OF THE DRAWINGS

The present invention will become more fully understood from the detailed description given herein below, and the accompanying drawings which are given by way of illustration only, and thus are not limitative of the present invention, and wherein;

FIG. 1 shows an exploded view of first composite material.

FIG. 2A shows an exploded view of first composite material, depicting joining elements.

FIG. 2B shows an exploded view of first composite material, depicting a variation in the location of joining elements.

FIG. 2C shows an exploded view of second composite material, depicting joining elements.

FIG. 2D shows an exploded view of third composite material, depicting joining elements.

FIG. 3 shows a perspective view of the first composite material.

FIG. 4A shows a perspective view of the first composite material, with outer substrate(s).

FIG. 4B shows a perspective view of the first composite material, with outer substrate(s).

FIG. 5A shows a perspective view of the first composite material.

FIG. 5B shows a perspective view of the second composite material.

FIG. 5C shows a perspective view of the third composite material.

FIG. 6A shows a partial cut-away view of the first composite material.

FIG. 6B shows a partial cut-away view of the second composite material.

FIG. 6C shows a partial cut-away view of the third composite material.

FIG. 6D shows a partial cut-away view of the fourth composite material.

FIG. 7A shows a perspective view of the first composite material, after operation of the cutter.

FIG. 7B shows a perspective view of the second composite material, after operation of the cutter.

FIG. 7C shows a perspective view of the third composite material, after operation of the cutter.

FIG. 7D shows a perspective view of the fourth composite material, after operation of the cutter.

FIG. 8A shows a perspective view of the first composite material, after operation of the cutter, and cut elements separated from the first composite material.

FIG. 8B shows a perspective view of the second composite material, after operation of the cutter, and cut elements separated from the second composite material.

FIG. 8C shows a perspective view of the third composite material, after operation of the cutter, and cut elements separated from the third composite material.

FIG. 8D shows a perspective view of the fourth composite material, after operation of the cutter, and cut elements separated from the fourth composite material.

FIG. 9A shows an exploded view of the fifth composite material.

FIG. 9B shows an exploded view of the sixth composite material.

FIG. 10A shows a perspective view of the fifth composite material.

FIG. 10B shows a perspective view of the sixth composite material.

FIG. 11 shows a perspective view of a mechanical press being brought into contact with a work piece.

FIG. 12A shows a perspective view of a mechanical press in contact with a work piece.

FIG. 12B shows a perspective view of a heat source positioned over a work piece.

FIG. 13 shows a perspective view of a mechanical press withdrawn from the work piece.

FIG. 14 shows a perspective view of a mechanical roller in contact with the work piece.

FIG. 15A shows a side view of a method of manufacturing the sixth composite material, using at least one mechanical roller.

FIG. 15B shows a side view of a method of manufacturing the sixth composite material, using at least one mechanical roller moving across the surface of the work piece.

FIG. 15C shows a side view of a method of manufacturing the sixth composite material, where the work piece is placed on a moving surface.

FIG. 16 shows a perspective view of a method of manufacturing the sixth composite material, using at least one mechanical roller.

FIG. 17 shows a perspective view of a method of manufacturing the sixth composite material, using at least one mechanical roller.

FIG. 18 shows a side view of a method of manufacturing the composite material, using at least one mechanical roller, depicting a carrier substrate together with a joining element, being brought into contact with a first resilient element.

FIG. 19 shows a perspective view of a method of manufacturing the composite material, using at least one mechanical roller, depicting a carrier substrate together with a joining element, being brought into contact with a first resilient element.

FIG. 20 shows a perspective view of a method of manufacturing the composite material, using at least one mechanical roller, depicting a carrier substrate together with a joining element, being brought into contact with a first resilient element.

FIG. 21 shows a side view of a method of manufacturing the composite material, using at least one mechanical roller, depicting a joining element being brought into contact with a first resilient element.

FIG. 22 shows a perspective view of a method of manufacturing the composite material, using at least one mechanical roller, depicting a joining element being brought into contact with a first resilient element.

FIG. 23 shows a perspective view of a method of manufacturing the composite material, using at least one mechanical roller, depicting a joining element being brought into contact with a first resilient element.

FIG. 24 shows a side view of a method of manufacturing the composite material, using at least one mechanical roller, depicting a carrier substrate being brought into contact with a joining element together with a first resilient element.

FIG. 25 shows a perspective view of a method of manufacturing the composite material, using at least one mechanical roller, depicting a carrier substrate being brought into contact with a joining element together with a first resilient element.

FIG. 26 shows a perspective view of a method of manufacturing the composite material, using at least one mechanical roller, depicting a carrier substrate being brought into contact with a joining element together with a first resilient element.

FIG. 27A shows a side view of a method of manufacturing a multi-layered composite with multiple resilient elements in which at least one mechanical roller is used, and the roller is stationary.

FIG. 27B shows a side view of a method of manufacturing a multi-layered composite with multiple resilient elements in which at least one mechanical roller is used, and the roller travels across the surface of the work piece.

FIG. 27C shows a side view of a method of manufacturing a multi-layered composite with multiple resilient elements in which at least one mechanical roller is used, and the work piece is placed on a moving surface.

FIG. 28 shows a perspective view of a method of manufacturing a multi-layered composite with multiple resilient elements in which at least one mechanical roller is used, and the roller is stationary.

FIG. 29 shows a perspective view of a method of manufacturing a multi-layered composite with multiple resilient elements in which at least one mechanical roller is used, and the roller is stationary.

FIG. 30 shows a side view of an alternative method of manufacturing a multi-layered composite with multiple resilient elements.

FIG. 31 shows a perspective view of an alternative method of manufacturing a multi-layered composite with multiple resilient elements.

FIG. 32 shows a perspective view of an alternative method of manufacturing a multi-layered composite with multiple resilient elements.

### DETAILED DESCRIPTION OF THE PREFERRED EMBODIMENTS

In the present application, “a” and “an” are used to refer to both single and a plurality of objects.

A. Multi-Layered Composite Materials

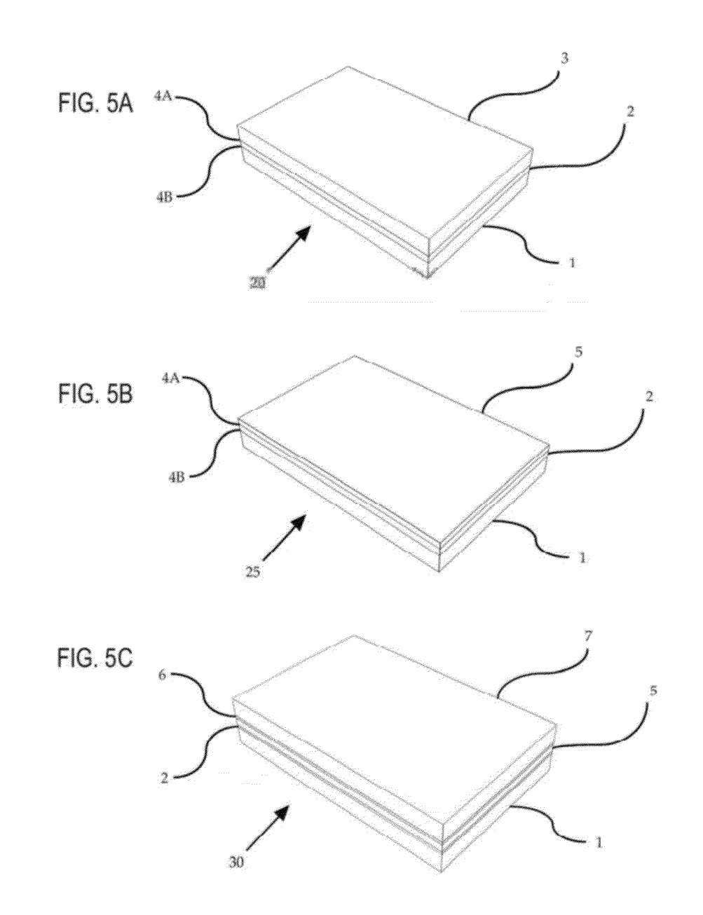

FIG. 3, and FIGS. 5A through 5C, depict various embodiments of the invention, namely, multi-layered composite materials comprised of at least two layers of resilient elements bonded together in a sheeting structure, in which at least two of the resilient elements are made of different types of materials, and are joined by means of a carrier substrate.

FIGS. 3 and 5A depict first composite material 20, comprised of first carrier substrate 2 which is bonded or attached to first resilient element 1 and to second resilient element 3.

FIG. 5B depicts second composite material 25, comprised of first carrier substrate 2, which is bonded or attached to first resilient element 1 and to third resilient element 5.

FIG. 5C depicts third composite material 30, comprised of the following: First carrier substrate 2, which is bonded or attached to first resilient element 1 and to third resilient element 5; third resilient element 5, which is also bonded or attached to second carrier substrate 6; and second carrier substrate 6, which is also bonded or attached to fourth resilient element 7.

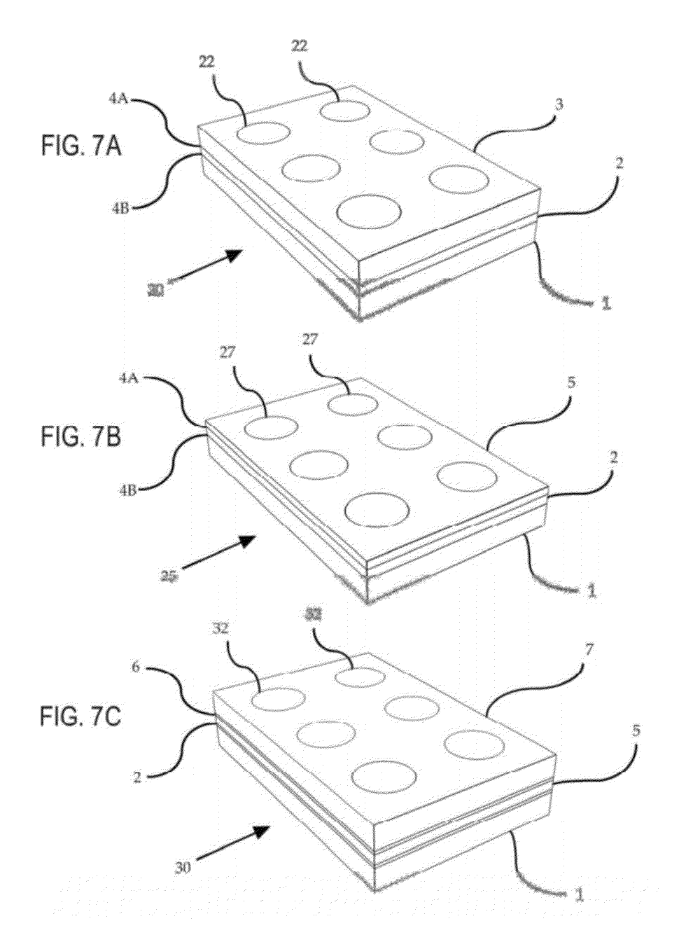

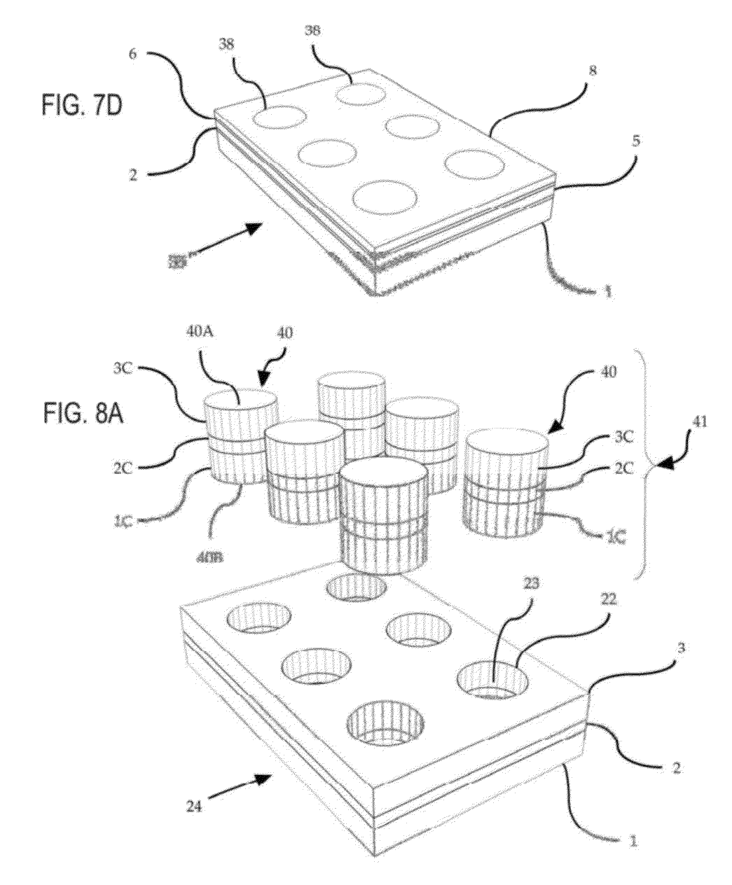

FIG. 7D depicts fourth composite material 35, comprised of the following: First resilient element 1, which is bonded or attached to first carrier substrate 2; first carrier substrate 2, which is also bonded or attached to third resilient element 5; third resilient element 5, which is also bonded or attached to second carrier substrate 6; and second carrier substrate 6, which is also bonded or attached to fifth resilient element 8.

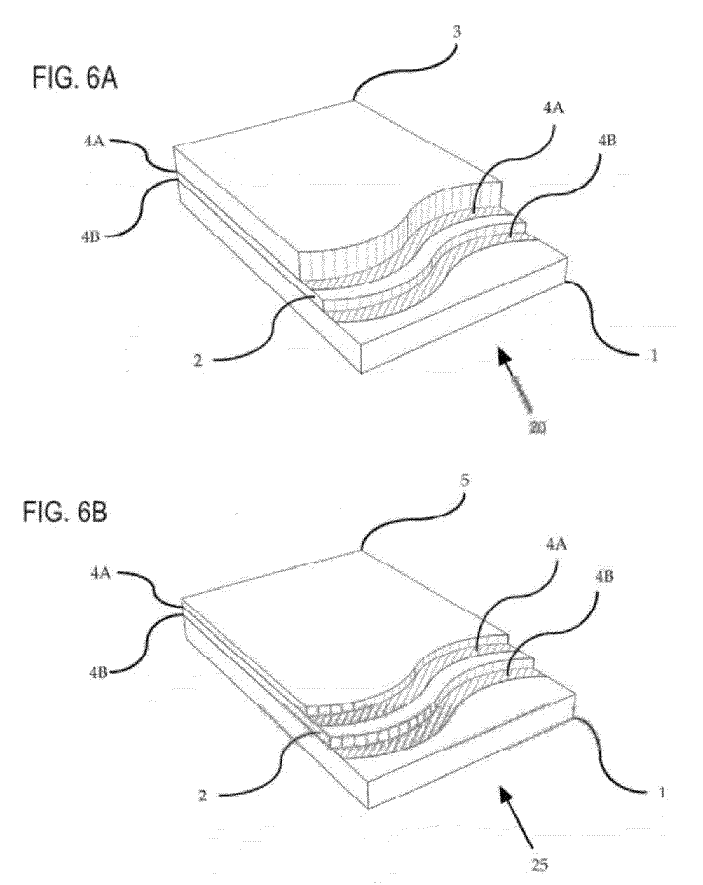

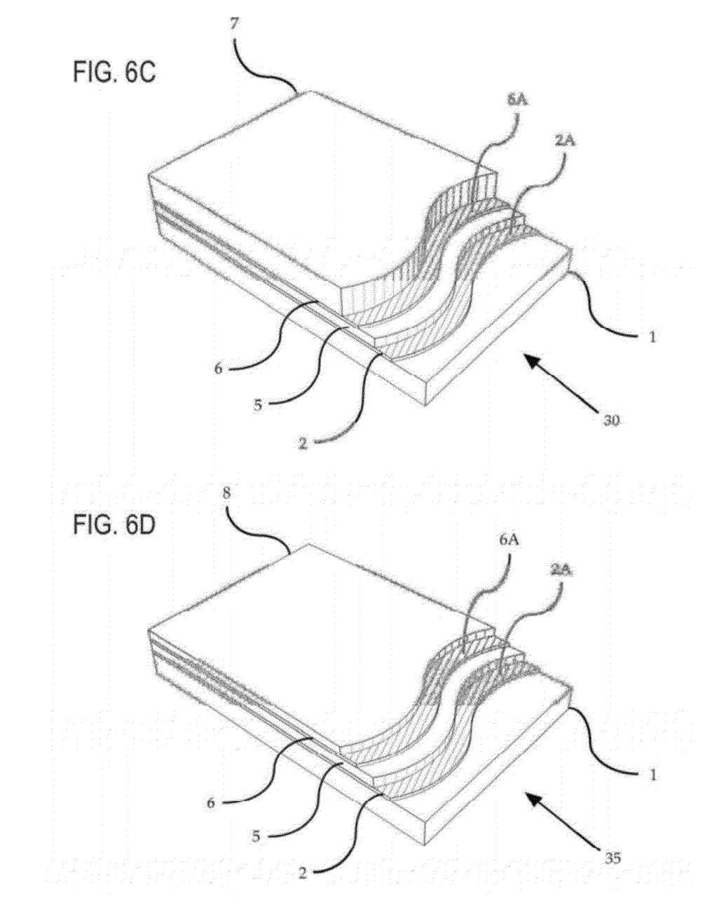

FIG. 6D depicts a partial cut-away view of fourth composite material 35, showing first resilient element 1, which is bonded or attached to first carrier substrate 2; third resilient element 5 which is bonded or attached to first side 2A of first carrier substrate 2; second carrier substrate 6, which is bonded to third resilient element 5; and fifth resilient element 8, which is bonded or attached to first side 6A of second carrier substrate 6.

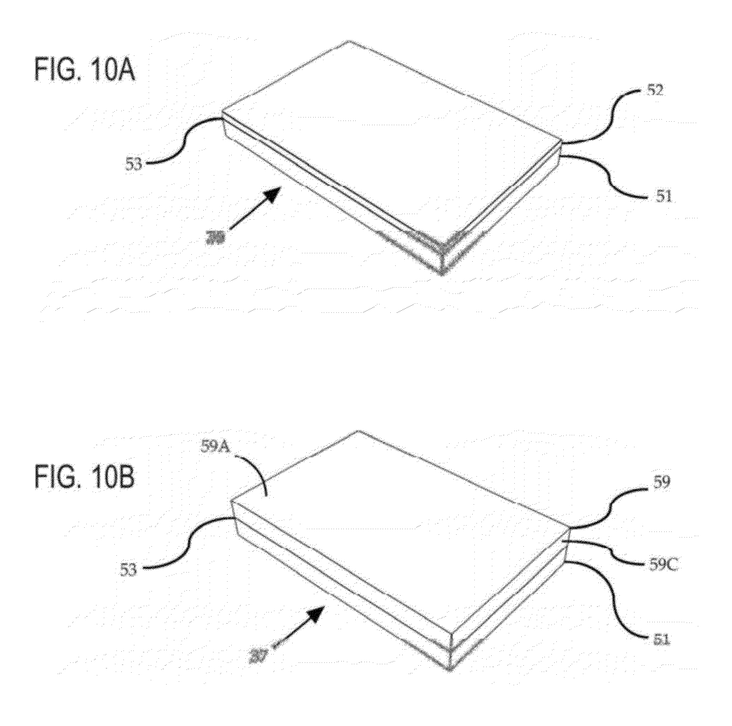

FIGS. 10A and 10B depict alternatively embodiments of the invention, namely, composite materials comprised of at least two layers of resilient elements bonded together in a sheeting structure, in which the resilient elements are made of the same type of materials.

FIG. 10A depicts fifth composite material 36, comprised of sixth resilient element 51 which is bonded or made to adhere to seventh resilient element 52.

FIG. 10B depicts sixth composite material 37, comprised of sixth resilient element 51 which is bonded or made to adhere to eighth resilient element 59.

A1. Multi-Layered Composite with Resilient Elements Made of Different Types of Materials

First Composite Material

FIGS. 3 and 5A depict first composite material 20, comprised of first carrier substrate 2 which is bonded or attached to first resilient element 1 and to second resilient element 3 by means of first carrier substrate 2.

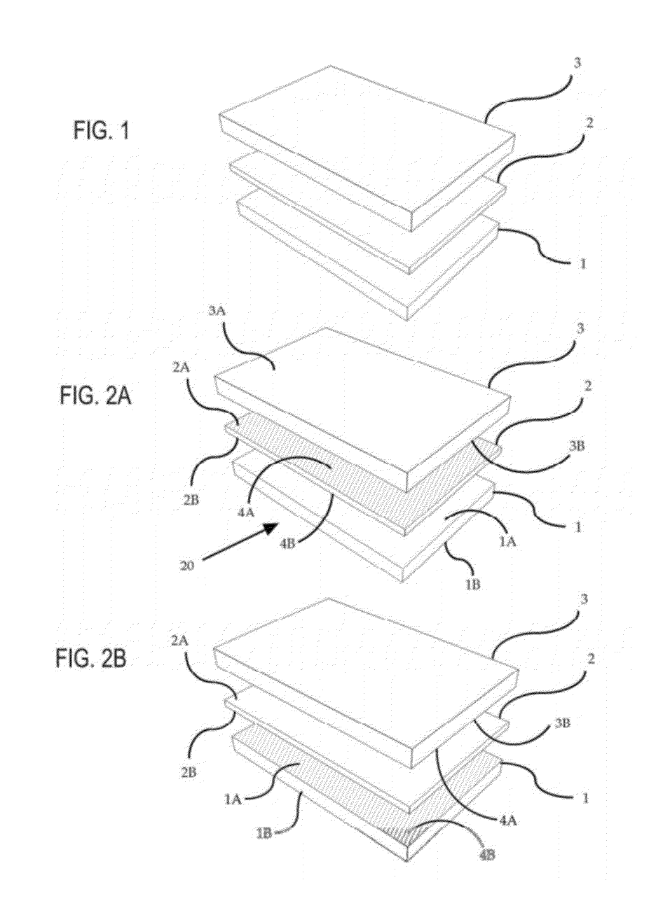

FIG. 1 depict some of the optional components of first composite material 20.

FIG. 6A depicts a partial cut-away view of first composite material 20, following assembly.

First resilient element 1, depicted in FIGS. 1, 2A, 2B, and 6A, is preferably made of ethylene vinyl acetate (“EVA”) foam. However, it is understood that first resilient element 1 may alternatively be made of olefin or polyolefin foam, or thermoplastic foam with shock absorbing characteristics, or resistant to puncture or abrasion. Optionally, first resilient element 1 may also be comprised of EVA, olefin, or polyolefin based sheeting, or a sheet of polyester, nylon, or other synthetic fabric. (It is understood that references in this application to various “first,” “second,” “third,” and “fourth” elements are used to distinguish or identify the various parts, components, and elements of the invention, and are not intended as a serial or numerical limitation).

First carrier substrate 2 is preferably made of non-woven fabric. However, it is understood that first carrier substrate 2 may alternatively be made of woven fabric, or may be comprised of a sheet of rubber, plastic, foam, mesh, natural or synthetic fiber, leather, paper, or other suitable material that may be made to adhere to first joining element 4A on one side, and to second joining element 4B on the other side.

It is also understood that first carrier substrate 2 may be comprised of layers of different types of materials glued to each other. By way of example only, and without limitations, first carrier substrate 2 may be comprised of more than one sheet or swatches of polyester or nylon, or a combination of the same, glued together with polyamine-based glue or hot-melt adhesive film.

Second resilient element 3 is preferably made of polyurethane (“PU”) foam. However, it is understood that second resilient element 3 may alternatively be made of other urethane based foam or material with shock absorbing characteristics, or resistant to puncture or abrasion. Optionally, second resilient element 3 may also be comprised of PU based synthetic leather, fabric, or sheet.

First carrier substrate 2 is positioned between first resilient element 1 and second resilient element 3, so that first side 2A of first carrier substrate 2 faces second side 3B of second resilient element 3, and second side 2B of first carrier substrate 2 faces first side 1A of first resilient element 1.

First joining element 4A is an adhesive, bonding agent, or mechanical means suitable for making first side 2A of first carrier substrate 2 adhere to second side 3B of second resilient element 3. Preferably, and optionally, first joining element 4A is comprised of polyurethane based hot-melt adhesive (“HMA”) film.

Second joining element 4B is an adhesive, bonding agent, or mechanical means suitable for making second side 2B of first carrier substrate 2 adhere to first side 1A of first resilient element 1. Preferably, and optionally, second joining element 4B is comprised of ethylene vinyl acetate, olefin, or polyolefin based hot-melt adhesive (“HMA”) film.

In an alternative and optional embodiment of the invention, the joining element may be comprised of a double-sided tape with a suitable adhesive coated on both sides, wherein the adhesive is activated by pressure, heat, or both.

In a more preferred embodiment, first carrier substrate 2 is polyester; first resilient element 1 is made of ethylene vinyl acetate (“EVA”) foam; second resilient element 3 is made of polyurethane (“PU”) foam; first joining element 4A is comprised of polyurethane based hot-melt adhesive (“HMA”) film; second joining element 4B is comprised of ethylene vinyl acetate, olefin, or polyolefin based hot-melt adhesive (“HMA”) film. In a preferred embodiment, EVA, olefin, or polyolefin based hot melt side of the polyester carrier is glued to EVA foam, and polyurethane based hot melt side of the polyester carrier is glued to PU foam, and the entire assembly is pressure-rolled with heated rollers.

In an alternative embodiment, first resilient element 1 is optionally made of ethylene vinyl acetate (“EVA”) foam, or a sheet of nylon, polyester, or other synthetic fabric; second resilient element 3 is made of a synthetic PU based leather fabric or sheet; first joining element 4A is comprised of polyurethane based hot-melt adhesive (“HMA”) film; and second joining element 4B is comprised of ethylene vinyl acetate, olefin, or polyolefin based hot-melt adhesive film.

First joining element 4A is preferably positioned on first side 2A of first carrier substrate 2, and second joining element 4B is preferably positioned on second side 2B of first carrier substrate 2.

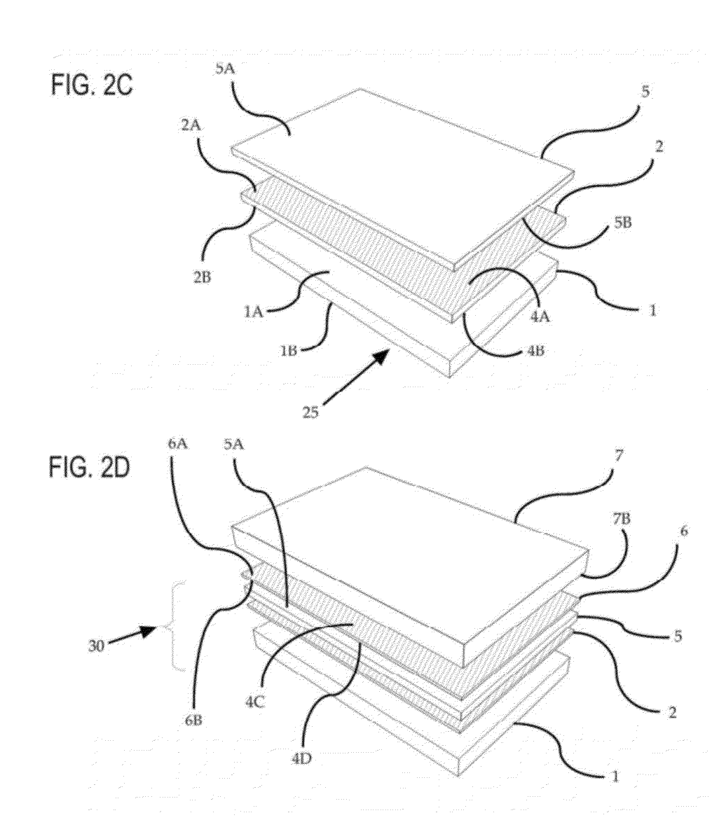

However, as depicted in FIG. 2B, in another embodiment of the invention, first joining element 4A may optionally be positioned on second side 3B of second resilient element 3. In yet another embodiment of the invention, second joining element 4B may optionally be positioned on first side 1A of first resilient element 1.

In another embodiment of the invention, first resilient element 1 is optionally made of polyurethane (“PU”) foam, elastomer, rubber, plastic, leather, foam, or other shock absorbing, or abrasion or puncture resistant material that may be made to adhere to second side 2B of first carrier substrate 2 by means of second joining element 4B, wherein second joining element 4B is selected by its ability to bond first resilient element 1 to first carrier substrate 2.

In yet another embodiment of the invention, second resilient element 3 is made of ethylene vinyl acetate (“EVA”) foam, olefin or polyolefin foam, thermoplastic foam, elastomer, rubber, plastic, leather, foam, or other shock, or abrasion or puncture resistant material that may be made to adhere to first side 2A of first carrier substrate 2 by means of first joining element 4A, wherein first joining element 4A is selected by its ability to bond second resilient element 3 to first carrier substrate 2.

FIGS. 3 and 5A depict first composite material 20 as rectangular in shape. However, it is understood that first composite material 20 may optionally be of any suitable shape and dimension, including thickness.

FIGS. 1, 2A and 2B depict the components of first composite material 20 as solid. However, it is understood that the components of first composite material 20 need not be solid, and that each component may optionally be perforated or include apertures. By way of example only, and without limitations, first resilient element 1, first carrier substrate 2, and second resilient element 3 may be perforated so as to enhance the flexibility, permeability, or breathability of the entire assembly.

Second Composite Material

It is understood that each component of first composite material 20 may optionally be of any suitable thickness, shape, or dimension. By way of example only, and without limitations, FIG. 5B depicts an alternative embodiment of the invention, namely second composite material 25, comprised of first carrier substrate 2 which is bonded or attached to first resilient element 1 and to third resilient element 5, wherein third resilient element 5 is different in thickness from first resilient element 1.

FIG. 2C depicts an exploded view of second composite material 25.

FIG. 6B depicts a partial cut-away view of second composite material 25, following assembly.

As depicted in FIGS. 2C and 6B, first resilient element 1 is bonded or attached to first carrier substrate 2 by means of second joining element 4B, and first carrier substrate 2 is bonded or attached to third resilient element 5 by means of first joining element 4A. Optionally, third resilient element 5 has a different or varying thickness in relation to second resilient element 3, but may be made of the same material and otherwise may be identical to second resilient element 3.

### Optional Embodiment

FIG. 3, and FIGS. 5A through 5C, depict various composite materials comprised of at least two layers of resilient elements bonded together in a sheeting structure, in which at least two of the resilient elements are made of different types of materials, and are joined by means of a carrier substrate.

However, it is understood that a carrier substrate may optionally be utilized to join sheets or layers of resilient elements of the same type, to form composite materials comprised of at least two layers of resilient elements bonded together in a sheeting structure, in which at least two of the resilient elements are made of the same type of material, and are joined by means of the carrier substrate.

By way of example only, and without limitations, first resilient element 1 and second resilient element 3 may optionally be made of the same type of material. In that case, a single type of joining element (that is, either first joining element 4A or second joining element 4B) may optionally be applied to the surfaces of first resilient element 1 and second resilient element 3 that face first carrier substrate 2. Alternatively, and optionally, the same joining element may be applied to each surface of first carrier substrate 2 that faces first resilient element 1 or second resilient element 3. In yet another alternative embodiment of the invention, different types of joining elements may be used (for example, first joining element 4A and second joining element 4B), provided that first joining element 4A is selected for its ability to bond first carrier substrate 2 to second resilient element 3, and second joining element 4B is selected for its ability to bond first carrier substrate 2 to first resilient element 1.

It is understood that depending on the selection of the carrier substrate and other components, the resulting composite material may have different characteristics from padding made of sheets of same types of resilient materials bonded to each other. By way of example only, and without limitations, relatively softer and more stretchable/compressible EVA foam may be selected for first resilient element 1 and second resilient element 3, and a more resilient, non-stretchable fabric, synthetic fiber, or other sheeting materials may be selected for first carrier substrate 2. By “sandwiching” the more resilient first carrier substrate 2 between layers of softer and more stretchable/compressible first resilient element 1 and second resilient element 3, it is possible to fabricate a composite material that is both soft and compressible along its vertical axis (that is, its thickness), but relatively less stretchable (and less subject to deformation) along the two horizontal axes.

Third Composite Material

FIGS. 3 and 5A depict composite materials incorporating, among other things, two resilient elements and a single carrier substrate. However, it is understood that more complex, multi-layered composite materials may be fabricated by stacking more than two layers or sheets of resilient elements made of same or different materials, by bonding or attaching the resilient elements to each other by means of additional intermediary layers comprised of carrier substrates, and suitable bonding agents applied over or placed next to the surfaces of each carrier substrate.

By way of example only, and without limitations, FIG. 5C depicts an alternative embodiment of the invention, namely, third composite material 30.

FIG. 2D depicts an exploded view of third composite material 30.

FIG. 6C depicts a partial cut-away view of third composite material 30, following assembly.

As depicted in FIGS. 2D, 5C, and 6C, first resilient element 1 is bonded or attached to first carrier substrate 2 by means of second joining element 4B, and first carrier substrate 2 is bonded or attached to third resilient element 5 by means of first joining element 4A, forming third composite material 30.

Second carrier substrate 6 is positioned between third resilient element 5 and fourth resilient element 7, so that first side 6A of second carrier substrate 6 faces second side 7B of fourth resilient element 7, and second side 6B of second carrier substrate 6 faces first side 5A of third resilient element 5.

Second side 6B of second carrier substrate 6 is bonded or attached to first side 5A of third resilient element 5 by means of fourth joining element 4D, which is optionally applied to or positioned over second side 6B of second carrier substrate 6. First side 6A of second carrier substrate 6 is bonded or attached to second side 7B of fourth resilient element 7 by means of third joining element 4C, which is optionally applied to or positioned over first side 6A of second carrier substrate 6.

Second carrier substrate 6 may optionally be made of non-woven or woven fabric, or may optionally be comprised of a sheet of rubber, plastic, foam, mesh, synthetic fiber, leather, paper, or other suitable material that may be made to adhere to third joining element 4C on one side, and to fourth joining element 4D on the other side. It is also understood that second carrier substrate 6 may be comprised of layers of different types of materials glued to each other. By way of example only, and without limitations, second carrier substrate 6 may be comprised of multiple sheets of polyester or nylon, or a combination of the same, bonded together with a polyamine-based adhesive or hot-melt adhesive film, or other suitable adhesive.

Fourth resilient element 7 may optionally be made of ethylene vinyl acetate (“EVA”) foam, olefin or polyolefin foam, thermoplastic foam, polyurethane (“PU”) foam, elastomer, rubber, plastic, leather, foam, or other shock, or abrasion or puncture resistant material that may be made to adhere to first side 6A of second carrier substrate 6 by means of third joining element 4C.

Third joining element 4C may optionally be comprised of any adhesive, bonding agent, or mechanical means of adhesion suitable for bonding fourth resilient element 7 to second carrier substrate 6. Depending on the composition of fourth resilient element 7 and second carrier substrate 6, third joining element 4C may be a hot-melt adhesive (“HMA”) film, glue, tape, or other chemical or mechanical means of adhesion.

In one embodiment of the invention, if fourth resilient element 7 is comprised of EVA, olefin, or polyolefin foam, third joining element 4C may optionally be an EVA, olefin, or polyolefin-based glue, HMA film, or other suitable adhesive. In another embodiment of the invention, if fourth resilient element 7 is comprised of PU foam, third joining element 4C may optionally be a PU-based glue, HMA film, or other suitable adhesive.

Fourth joining element 4D may optionally be comprised of any adhesive, bonding agent, or mechanical means of adhesion suitable for bonding third resilient element 5 to second carrier substrate 6. Depending on the composition of third resilient element 5 and second carrier substrate 6, fourth joining element 4D may be a hot-melt adhesive (“HMA”) film, glue, tape, or other chemical or mechanical means of adhesion.

In one embodiment of the invention, if third resilient element 5 is comprised of EVA, olefin, or polyolefin foam, fourth joining element 4D may optionally be an EVA, olefin, or polyolefin-based glue, HMA film, or other suitable adhesive. In another embodiment of the invention, if third resilient element 5 is comprised of PU foam, the fourth joining element 4D may optionally be a PU-based glue, HMA film, or other suitable adhesive.

Fourth Composite Material

It is understood that the individual components of the composite material may be dimensioned to suit the intended use of the composite material, and that the thickness of the individual components may also vary for that purpose.

By way of example only, and without limitations, FIG. 7D depicts a composite material that is a variation of third composite material 30, wherein fourth resilient element 7 is replaced by a thinner fifth resilient element 8, to form fourth composite material 35. FIG. 6D depicts the partial cut-away view of fourth composite material 35.

The finished multi-layered composite materials, such as first composite material 20, second composite material 25, third composite material 30, and fourth composite material 35 may optionally be used as pads, padding, or cushioning material, or attached to or incorporated into clothing or protective equipment, without further modification.

Optionally Packaged Composite Materials

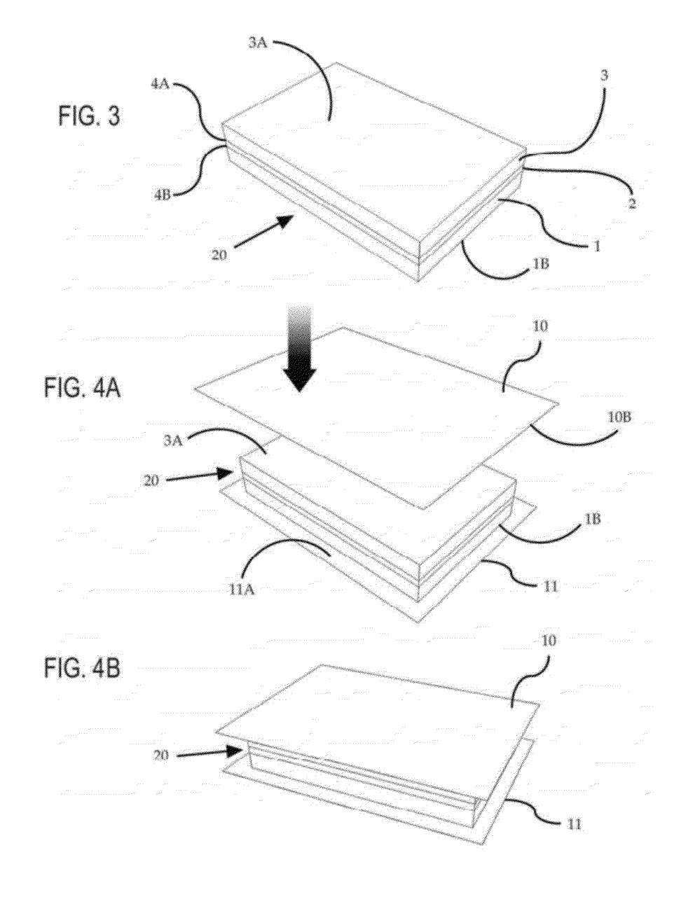

Optionally, the finished composite material may be further modified or packaged by bonding one or more substrates to the top and bottom layers of the same. As depicted in FIGS. 4A and 4B, in one embodiment of the invention, first outer substrate 10 is optionally bonded to first composite material 20, so that second side 10B of first outer substrate 10 faces first side 3A of second resilient element 3. In another embodiment of the invention, second outer substrate 11 is optionally bonded to first composite material 20, so that first side 11A of second outer substrate 11 faces second side 1B of first resilient element 1.

First outer substrate 10 and second outer substrate 11 may optionally be made of non-woven or woven fabric, synthetic fiber, rubber, plastic, elastomer, silicone sheeting, or leather. It is understood that first outer substrate 10 and second outer substrate 11 may optionally be made of the same type of material, or may be made of different types of materials.

It is understood that any suitable means may be used to optionally bond first outer substrate 10 to second resilient element 3, and to optionally bond second outer substrate 11 to first resilient element 1, including, without limitations, hot-melt adhesive (“HMA”) film, glue, tape, or other chemical or mechanical means of adhesion.

Cushioning Components Made from Composite Materials

It is understood that in one aspect of the invention, the finished multi-layered composite material, such as first composite material 20, second composite material 25, third composite material 30, and fourth composite material 35, may optionally be cut into different shapes and dimensions, for use as pads, padding, cushioning material, or components therefor, or to be attached to or incorporated into cushioning gear, or protective equipment or clothing.

First Cushioning Component

FIG. 7A depicts first composite material 20. A cutter is pressed against first composite material 20, forming a cut sheet of material comprising a plurality of cut elements, where each cut element has a shape 22 corresponding to the shape of the internal space of its corresponding cutter elements.

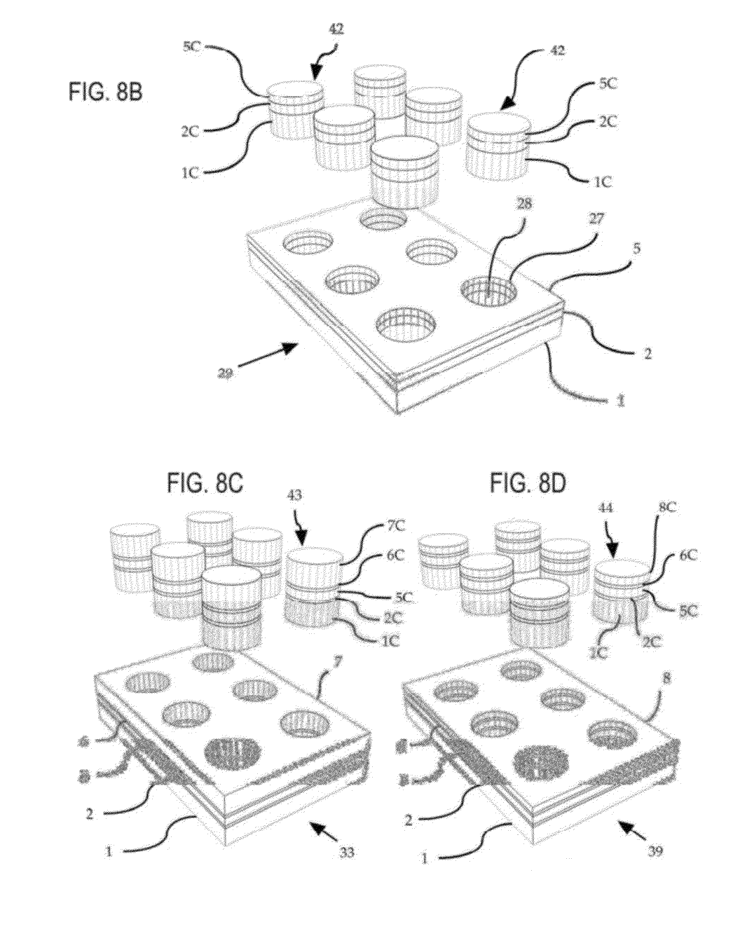

As depicted in FIG. 8A, the cut elements outlined by shape 22 are separated from first composite material 20 to form first cushioning component 40, leaving behind first lattice 24 with a plurality of apertures 23 corresponding to the outline of shape 22.

First cushioning component 40 is comprised of multiple layers of materials, namely, layers 1C, 2C, and 3C, corresponding to the components of first composite material 20. One or more instances of first cushioning component 40, or first array of cushioning components 41, may be used as pads, padding, cushioning material, or components therefor, or be attached to or incorporated into cushioning gear, or protective equipment or clothing.

Optionally, one or more first cushioning components 40 may be attached to first outer substrate 10, by bonding first surface 40A of first cushioning component 40 to second side 10B of first outer substrate 10. Also optionally, one or more first cushioning component 40 may be attached to second outer substrate 11, by bonding second surface 40B of first cushioning components 40 to first side 11A of second outer substrate 11.

Second Cushioning Component

FIG. 7B depicts second composite material 25. A cutter is pressed against second composite material 25, forming a cut sheet of material comprising a plurality of cut elements, where each cut element has a shape 27 corresponding to the shape of the internal space of its corresponding cutter elements.

As depicted in FIG. 8B, the cut elements outlined by shape 27 are separated from second composite material 25 to form second cushioning component 42, leaving behind second lattice 29 with a plurality of apertures 28 corresponding to the outline of shape 27.

Second cushioning component 42 is comprised of multiple layers of materials, namely, layers 1C, 2C, and 5C, corresponding to the components of second composite material 25. One or more instances of second cushioning component 42 may be used as pads, padding, cushioning material, or components therefor, or be attached to or incorporated into cushioning gear, or protective equipment or clothing.

Optionally, one or more second cushioning components 42 may also be attached to first outer layer substrate 10. Also optionally, one or more second cushioning components 42 may also be attached to second outer layer substrate 11.

Third Cushioning Component

FIG. 7C depicts third composite material 30. A cutter is pressed against third composite material 30, forming a cut sheet of material comprising a plurality of cut elements, where each cut element has a shape 32 corresponding to the shape of the internal space of its corresponding cutter elements.

As depicted in FIG. 8C, third cushioning component 43 may be fabricated by cutting third composite material 30 and separating individual third cushioning components 43 from the same, leaving behind third lattice 33 with a plurality of apertures corresponding to the outline of shape 32. Third cushioning component 43 is comprised of multiple layers of materials, namely, layers 7C, 6C, 5C, 2C, and 1C, corresponding to the components of third composite material 30. One or more instances of third cushioning component 43 may be used as pads, padding, cushioning material, or components therefor, or be attached to or incorporated into cushioning gear, or protective equipment or clothing.

Optionally, one or more third cushioning components 43 may also be attached to first outer layer substrate 10. Also optionally, one or more third cushioning components 43 may also be attached to second outer layer substrate 11.

Fourth Cushioning Component

FIG. 7D depicts fourth composite material 35. A cutter is pressed against fourth composite material 35, forming a cut sheet of material comprising a plurality of cut elements, where each cut element has a shape 38 corresponding to the shape of the internal space of its corresponding cutter elements.

As depicted in FIG. 8D, fourth cushioning component 44 may be fabricated by cutting fourth composite material 35 and separating individual fourth cushioning components 44 from the same, leaving behind fourth lattice 39 with a plurality of apertures corresponding to the outline of shape 38. Fourth cushioning component 44 is comprised of multiple layers of materials, namely, layers 8C, 6C, 5C, 2C, and 1C, corresponding to the components of fourth composite material 35. One or more instances of fourth cushioning component 44 may be used as pads, padding, cushioning material, or components therefor, or be attached to or incorporated into cushioning gear, or protective equipment or clothing.

Optionally, one or more fourth cushioning components 44 may also be attached to first outer layer substrate 10. Also optionally, one or more fourth cushioning components 44 may also be attached to second outer layer substrate 11.

While, shape 22, shape 27, shape 32, and shape 38 are optionally depicted as circular in shape, it is understood that they may have different shapes and dimensions. By way of example only, and without limitations, shape 22, shape 27, shape 32, and shape 38 may optionally be triangular, rectangular, pentagonal, or hexagonal in shape, or be irregularly shaped.

First cushioning component 40, second cushioning component 42, third cushioning component 43, and fourth cushioning component 44 are optionally depicted as cylindrical in shape, corresponding to shape 22, shape 27, shape 32, and shape 38, respectively. However, it is understood that the cushioning components may have different shapes and dimensions. By way of example only, and without limitations, first cushioning component 40, second cushioning component 42, third cushioning component 43, fourth cushioning component 44 may optionally be pyramidal or cubic in shape, a pentagonal tube or pyramid, a hexagonal tube or pyramid, or be irregularly shaped.

It is understood that first composite component 40, second composite component 42, third composite component 43, and fourth composite component 44 may be further modified or packaged by optionally bonding one or more of them to first outer substrate 10 or to second outer substrate 11, in the manner depicted in FIGS. 4A and 4B. By way of clarification, it is also understood that different types of cushioning components (such as first cushioning component 40, second cushioning component 42, third cushioning component 43, and fourth cushioning component 44) may be mixed, positioned and composed in an array, placed between first outer substrate 10 and second outer substrate 11, and bonded to the outer substrates.

A2. Multi-Layered Composite with Resilient Elements Made of the Same Type of Materials

Fifth Composite Material

FIG. 10A depicts fifth composite material 36, comprised of sixth resilient element 51 which is bonded or made to adhere to seventh resilient element 52 by means of fifth joining element 53.

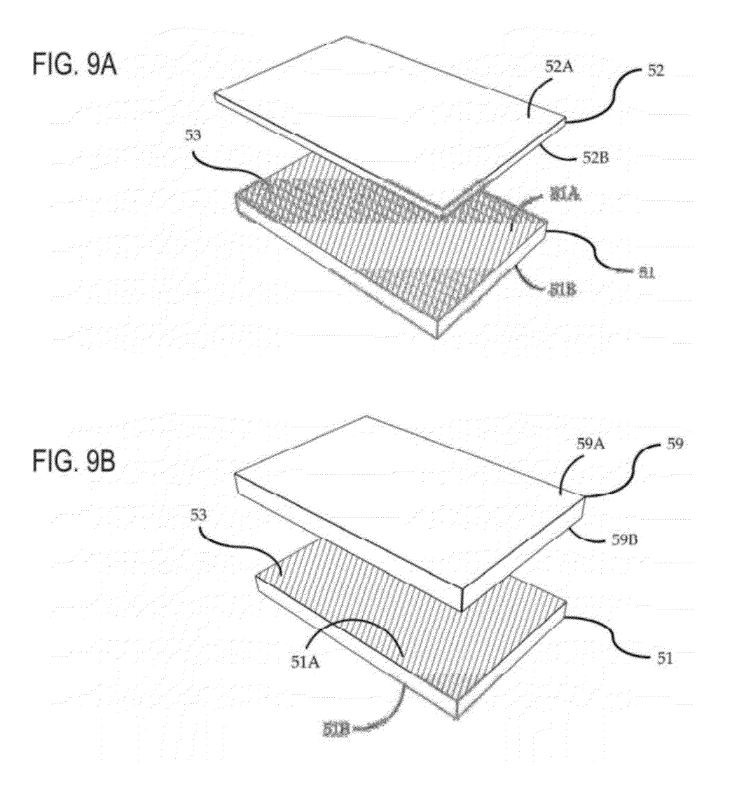

FIG. 9A depicts an exploded view of fifth composite material 36. As depicted in FIG. 9A, fifth joining element 53 may be positioned next to, or applied over, first side 51A of sixth resilient element 51. Optionally, and alternatively, fifth joining element 53 may be positioned next to, or applied over, second side 52B of seventh resilient element 52. Sixth resilient element 51 is positioned adjacent to seventh resilient element 52, so that first side 51A of sixth resilient element 51 faces second side 52B of seventh resilient element 52, and fifth joining element 53 is positioned between the two of them. The entire assembly is pressed or optionally heat-pressed for bonding.

Sixth resilient element 51 may optionally be made of ethylene vinyl acetate (“EVA”) foam, olefin or polyolefin foam, or thermoplastic foam with shock absorbing characteristics, or relative resistance to puncture or abrasion. Optionally, and alternatively, sixth resilient element 51 may be made of polyurethane (“PU”) foam, or other urethane based foam or material with shock absorbing characteristics, or relative resistance to puncture or abrasion. In another embodiment of the invention, sixth resilient element 51 may optionally be made of elastomer, rubber, plastic, leather, foam, or other shock, or abrasion or relatively puncture resistant material.

Seventh resilient element 52 may optionally be made of ethylene vinyl acetate (“EVA”) foam, olefin or polyolefin foam, or thermoplastic foam with shock absorbing characteristics, or relative resistance to puncture or abrasion. Optionally, and alternatively, seventh resilient element 52 may be made of polyurethane (“PU”) foam, or other urethane based foam or material with shock absorbing characteristics, or relative resistance to puncture or abrasion. In another embodiment of the invention, seventh resilient element 52 may optionally be made of elastomer, rubber, plastic, leather, foam, or other shock, or abrasion or relatively puncture resistant material.

In one embodiment of the invention, sixth resilient element 51 and seventh resilient element 52 are optionally made of the same type of materials. In another embodiment of the invention, sixth resilient element 51 and seventh resilient element 52 are optionally made of the same type of materials, but display different qualities, features, or performance characteristics. In yet another embodiment of the invention, sixth resilient element 51 and seventh resilient element 52 are optionally made of different types of materials, provided, however, that sixth resilient element 51 and seventh resilient element 52 are capable of being joined or bonded together by means of fifth joining element 53.

In a more preferred embodiment, it is desired to make a dual density foam composite. EVA foam sheet is coated with EVA, olefin, or polyolefin based hot melt adhesive film. Then the coated EVA foam sheet is placed next to another EVA foam sheet with lower density or hardness and the two sheets are “fed” into a machine with a heating element such as heating element 63 facing the two bonding surfaces. Infrared heaters may be used to soften and melt or activate the HMA film and the EVA sheet coated with the said HMA film, and then the coated EVA foam sheet and an uncoated EVA foam sheet placed next to it may be “fed” or laminated through a machine such as a roller machine. Such a “dual density” foam composite may be further laminated with fabrics on either one or both sides and attached to protective wear or to garments.

Fifth joining element 53 may optionally be comprised of any adhesive, bonding agent, or mechanical means of adhesion suitable for bonding sixth resilient element 51 to seventh resilient element 52. Depending on the composition of sixth resilient element 51 and seventh resilient element 52, fifth joining element 53 may be a hot-melt adhesive (“HMA”) film, glue, tape, or other chemical or mechanical means of adhesion.

In one embodiment of the invention, the fifth joining element 53 may optionally be comprised of ethylene-vinyl acetate (“EVA”), olefin, or polyolefin based adhesive or HMA film, in the event that sixth resilient element 51 and seventh resilient element 52 are made of ethylene vinyl acetate (“EVA”) foam, olefin or polyolefin foam, thermoplastic foam, or other materials that may be joined or cross-link with EVA, olefin, or polyolefin based adhesive or HMA film.

In another embodiment of the invention, the fifth joining element 53 may optionally be comprised of polyurethane (“PU”) based adhesive or HMA film, in the event that sixth resilient element 51 and seventh resilient element 52 are made of polyurethane foam or other materials that may be joined or cross-link with PU based adhesive or HMA film.

FIG. 10A depicts fifth composite material 36 as rectangular in shape. However, it is understood that fifth composite material 36 may optionally be of any suitable shape and dimension.

Sixth Composite Material

FIG. 10A also depicts two components of fifth composite material 36, namely, sixth resilient element 51 and seventh resilient element 52, as having different thicknesses. However, it is understood that each component of fifth composite material 36 may also be of any suitable shape and dimension, including thickness.

For example, FIG. 10B depicts sixth composite material 37, comprised of sixth resilient element 51 which is bonded or made to adhere to eighth resilient element 59 by means of fifth joining element 53. Eighth resilient element 59 has a different or varying thickness in relation to seventh resilient element 52, but may be made of the same material and otherwise may be identical to seventh resilient element 52.

FIG. 9B depict an exploded view of sixth composite material 37. As shown in FIG. 9B, fifth joining element 53 may be positioned next to, or applied over, first side 51A of sixth resilient element 51. Optionally, and alternatively, fifth joining element 53 may be positioned next to, or applied over, second side 59B of eighth resilient element 59. The components are brought together, and the entire assembly may be compressed for bonding.

FIGS. 10A and 10B depict fifth composite material 36 and sixth composite material 37 as solid. However, it is understood that, optionally, fifth composite material 36 and sixth composite material 37, and any one or more of their components, may be perforated or include apertures to enhance flexibility, permeability, or breathability of the entire assembly.

B. Method of Making Multi-Layered Composite Materials

B1. Manufacture of Multi-Layered Composite with Resilient Elements Made of Different Types Of Materials

Method of Making Multi-Layered Composite with Resilient Elements Made of Different Types of Materials

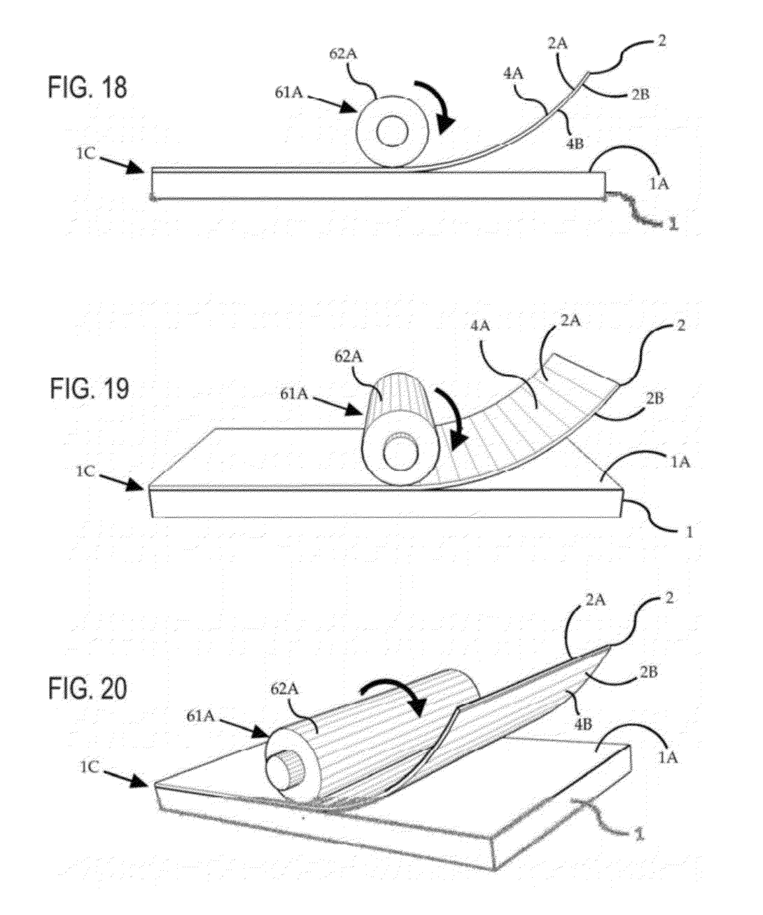

FIGS. 18 through 23 depict a method of manufacturing multi-layered composite materials, such as first composite material 20, second composite material 25, third composite material 30, and fourth composite material 35.

As a preliminary step, second joining element 4B is placed next to, or applied over, second side 2B of first carrier substrate 2. Optionally, first joining element 4A is place next to, or applied over, first side 2A of first carrier substrate 2. By way of example only, and without limitations, FIGS. 18, 19, and 20 depict first carrier substrate 2 with first joining element 4A placed next to, or applied over, first side 2A of first carrier substrate 2, and with second joining element 4B placed next to, or applied over, second side 2B of first carrier substrate 2.

As also depicted in FIGS. 18, 19, and 20, first carrier substrate 2 is bonded or laminated to first resilient element 1, as follows: First carrier substrate 2 is positioned next to, or over, first resilient element 1, so that second side 2B of first carrier substrate 2 faces first side 1A of first resilient element 1. Because second joining element 4B has been placed next to, or applied over, second side 2B of first carrier substrate 2, second joining element 4B is “sandwiched” between second side 2B of first carrier substrate 2 and first side 1A of first resilient element 1.

First mechanical roller 61A is positioned adjacent to or over the arranged work piece and presses against the same, so that each component (that is, first carrier substrate 2, second joining element 4B, and first resilient element 1) is compressed against the other adjacent components, and makes contact with the facing surfaces of the same.

If second joining element 4B is a hot-melt adhesive film or other bonding agent that is activated by heat, first mechanical roller 61A may optionally incorporate first heated roller element 62A. Also optionally, the surface of first mechanical roller 61A may incorporate or be coated with one or more non-reactive materials (such as silicone, polytetrafluoroethylene/PTFE, perfluoroalkoxy/PFA, fluorinated ethylene propylene/FEP, Teflon, or other similar non-reactive material) that do not adhere to the joining elements.

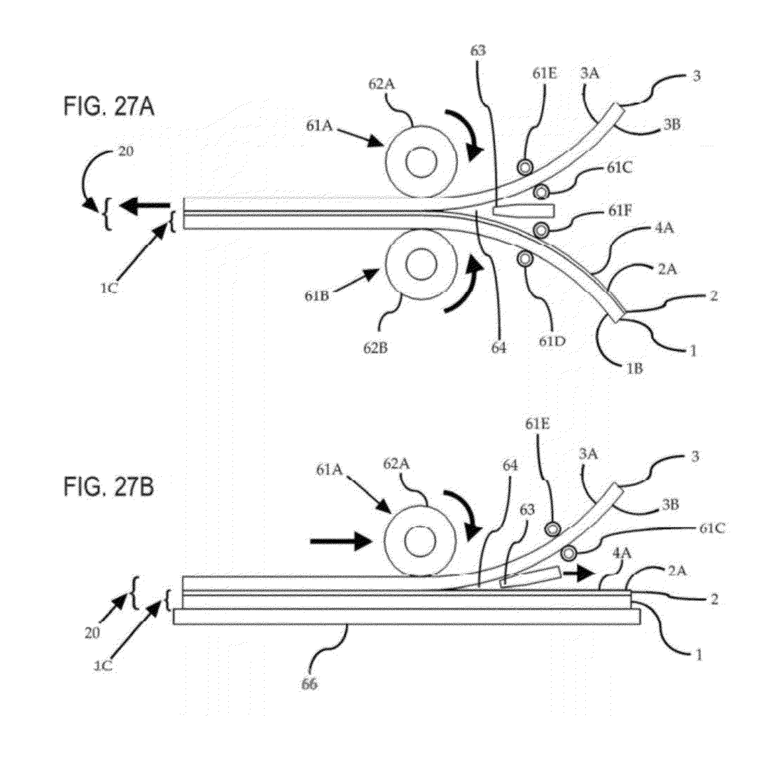

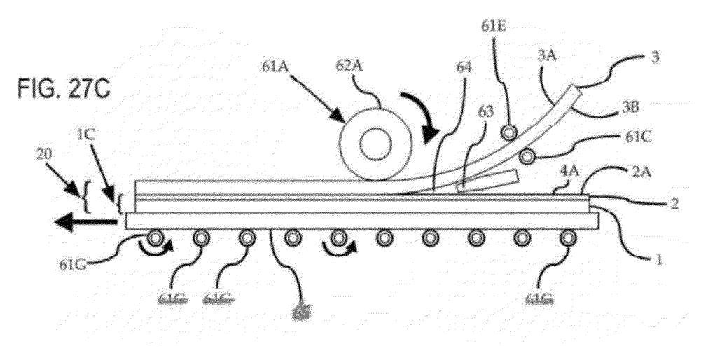

It is understood that first mechanical roller 61A may be mounted on a moving mechanism that enables first mechanical roller 61A to travel across the surface of the arranged work piece while exerting pressure over the entire assembly. Alternatively, and optionally, the arranged work piece may be placed on a moving surface 66 (such as a conveyer belt) such as illustrated in FIG. 27C or on a mechanism that permits the arranged work piece to travel in the direction compatible with the rotation of first mechanical roller 61A, while first mechanical roller 61A remains stationary as it rotates and exerts downward pressure.

Following the pressing or heat-pressing operation, first resilient element 1 is bonded or made to adhere to first carrier substrate 2 by means of second joining element 4B, thus forming partial laminate 1C.

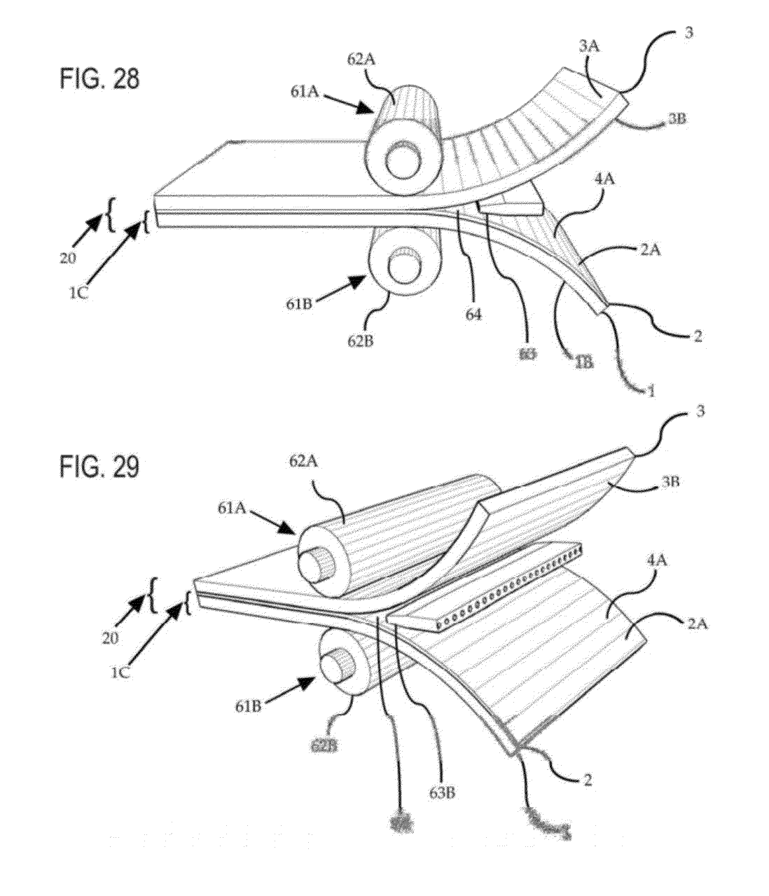

As depicted in FIGS. 27A-27C, 28, and 29, second resilient element 3 is positioned or placed adjacent to partial laminate 1C (consisting of first resilient element 1 bonded or made to adhere to first carrier substrate 2 by means of second joining element 4B), so that second side 3B of second resilient element 3 is facing first side 2A of first carrier substrate 2.

As also depicted in FIGS. 27A-27C, 28, and 29, first mechanical roller 61A is positioned adjacent to or against first side 3A of second resilient element 3, so that first mechanical roller 61A touches and optionally presses against the same. If first joining element 4A is a hot-melt adhesive film or other bonding agent that is activated by heat, first mechanical roller 61A may optionally incorporate first heated roller element 62A. It is understood that first heated roller element 62A may be any device, mechanism, or means to heat the surface of first mechanical roller 61A as it compresses second resilient element 3.

Optionally, a second mechanical roller 61B may be positioned adjacent to or against second side 1B of first resilient element 1, so that second mechanical roller 61B touches and optionally presses against the same, as depicted in FIGS. 27A, 28, and 29. Optionally, second mechanical roller 61B may also incorporate second heated roller element 62B. It is understood that second heated roller element 62B may be any device, mechanism, or means to heat the surface of second mechanical roller 61B as it touches or compresses first resilient element 1.

As depicted in FIGS. 27A-27C, 28, and 29, heating element 63 is positioned between second resilient element 3 and partial laminate 1C, and made to raise the temperature in heating zone 64, where second side 3B of second resilient element 3 is in relative proximity to the surface of first joining element 4A, and is facing first side 2B of first resilient element 1.

Heating element 63 may optionally be comprised of one or more gas heaters, electric heaters, infrared heaters, ultrasound or radio frequency heaters, or any other device, mechanism, or means of increasing the temperature at heating zone 64. Heating element 63 must enable the temperature at the heating zone 64 to rise to the point where first joining element 4A activates, liquefies, melts, cross-links, or bonds with second resilient element 3, or otherwise causes first carrier substrate 2 to bond or adhere to second resilient element 3.

Heating element 63 may be placed or positioned in any location that enables the temperature at heating zone 64 to rise to a point where first joining element 4A activates, liquefies, melts, cross-links, or otherwise causes first carrier substrate 2 to bond or adhere to second resilient element 3, without damaging or degrading the other components of the arranged work piece (that is, first resilient element 1, first carrier substrate 2, second joining element 4B, and second resilient element 3).

In one embodiment of the invention, first resilient element 1 is optionally comprised of material that is denser or has higher melting temperature than second resilient element 3, and heating element 63 is optionally positioned so that the heat generated by heating element 63 is directed primarily to the surface area of first resilient element 1 located within heating zone 64.

As depicted in FIG. 27A, in one embodiment of the invention, first mechanical roller 61A, second mechanical roller 61B, and heating element 63 remain stationary. First mechanical roller 61A and second mechanical roller 61B are placed in relation to each other so that there is sufficient spacing between them (preferably and optionally equal to or less than the total combined thickness of first resilient element 1, first carrier substrate 2, first joining element 4A, second joining element 4B, and second resilient element 3 stacked together) to permit the arranged work piece to pass through the spacing, preferably and optionally in a compressed state.

As also depicted in FIG. 27A, first mechanical roller 61A and second mechanical roller 61B rotate in opposite directions. In one embodiment of the invention, partial laminate 1C and second resilient element 3 are inserted (“fed”) into the spacing between the two mechanical rollers, and the mechanical rollers compress the components. If one or more heated roller components (that is, first heated roller element 62A and second heated roller element 62B) are optionally present, the components are heat-compressed by the rollers.

Optionally, and alternatively, first mechanical roller 61A may be mounted on a moving mechanism that enables first mechanical roller 61A to travel across the surface of the arranged work piece while exerting pressure against it. It is understood that second mechanical roller 61B may also be optionally mounted on a moving mechanism that enables second mechanical roller 61B to travel across the surface of the arranged work piece while exerting pressure against it.

In another embodiment of the invention, as depicted in FIG. 27B, partial laminate 1C may optionally be placed on a static work surface. First mechanical roller 61A and heating element 63 may optionally be mounted on a moving mechanism that enables first mechanical roller 61A to travel across the surface of the arranged work piece while exerting pressure against it. Optionally, heating element 63 may also be mounted on a moving mechanism that enables heating element 63 to travel along the length of the work piece.

In yet another embodiment of the invention, as depicted in FIG. 27C, the arranged work piece may optionally be placed on a moving surface 66 (such as, by way of example only and without limitations, a conveyer belt) or other mechanism (such as, by way of example only and without limitations, a plurality of fifth supporting rollers 61G) that permits the arranged work piece to travel in a direction compatible with the rotation of first mechanical roller 61A, while heating element 63 and first mechanical roller 61A remain stationary, and while first mechanical roller 61A rotates and exerts pressure against the work piece and compresses the same.

It is understood that during the pressing or heat-pressing operation, mechanical rollers, guides, holders, or other supporting devices, mechanisms, or means may optionally be utilized to support or guide partial laminate 1C and second resilient element 3. By way of example only, and without limitations, FIG. 27A depicts optional first supporting roller 61C, supporting or guiding second resilient element 3 in the course of the pressing or heat-pressing operation, and optional second supporting roller 61D, supporting or guiding partial laminate 1C in the course of the pressing or heat-pressing operation.

It is also understood that any number of rollers, guides, holders, or other supporting devices, mechanisms, or means may be optionally deployed and placed in a variety of optional and alternative locations to support or guide partial laminate 1C and second resilient element 3 during the pressing or heat-pressing operation. By way of example only, and without limitations, FIG. 27A, depicts optional third supporting roller 61E, intended to hold, support, or guide second resilient element 3, and fourth supporting roller 61F, intended to hold, support, or guide partial laminate 1C.

Upon completion of the pressing or heat-pressing operation, second resilient element 3 is bonded to partial laminate 1C, forming first composite material 20. Other types of composite materials (such as second composite material 25, third composite material 30, and fourth composite material 35) may be fabricated through the same or substantially similar process.

First composite material 20 is comprised of two layers of resilient elements bonded together in a sheeting structure, and joined by means of a carrier substrate. Preferably, although optionally, the two resilient elements in first composite material 20 are made of different types of materials.

However, it is understood that the fabrication process described above may optionally be used to make composite materials comprised of at least two layers of resilient elements bonded together in a sheeting structure, in which at least two of the resilient elements are made of the same type of material, and are joined by means of a carrier substrate. By way of clarification, the same process described above may optionally be used to fabricate a variation of first composite material 20, wherein first resilient element 1 and second resilient element 3 are optionally comprised of the same type of material.

First Alternative Method of Making Multi-Layered Composite with Resilient Elements Made of Different Types of Materials

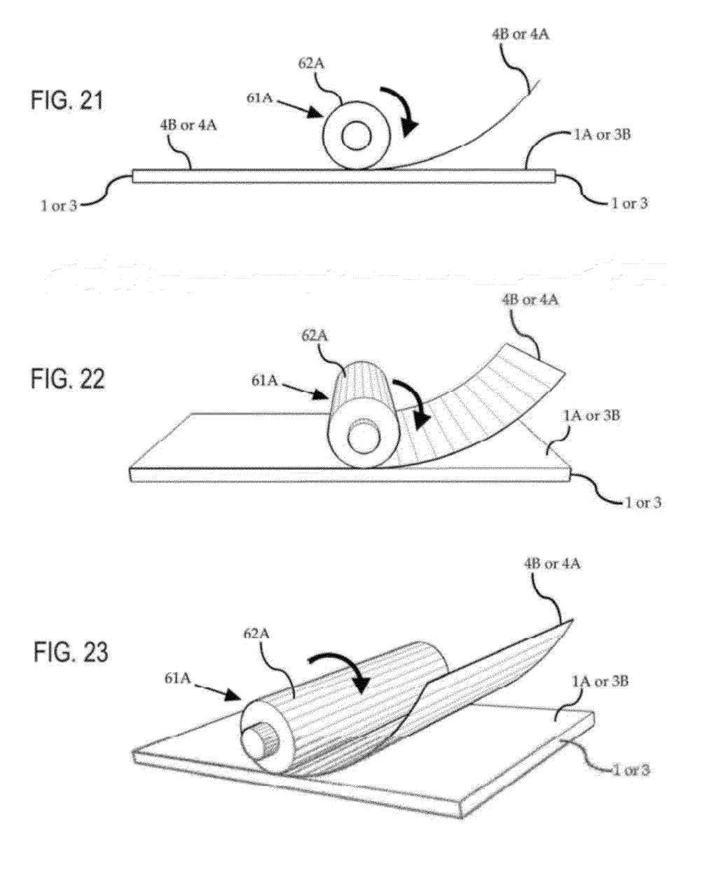

FIGS. 21 through 26, inclusive, depict an alternative embodiment of the invention. FIGS. 21, 22, and 23 depict a preliminary step, wherein second joining element 4B is optionally placed next to, or applied over, first side 1A of first resilient element 1, rather than applied to second side 2B of first carrier substrate 2. The assembly is pressed or heat-pressed by using first mechanical roller 61, which may optionally incorporate first heated roller element 62A.

As also depicted in FIGS. 21, 22, and 23, first joining element 4A may be optionally placed next to, or applied over, second side 3B of second resilient element 3, rather than applied to first side 2A of first carrier substrate 2. The assembly is pressed or heat-pressed by using first mechanical roller 61A, which may optionally incorporate first heated roller element 62A.

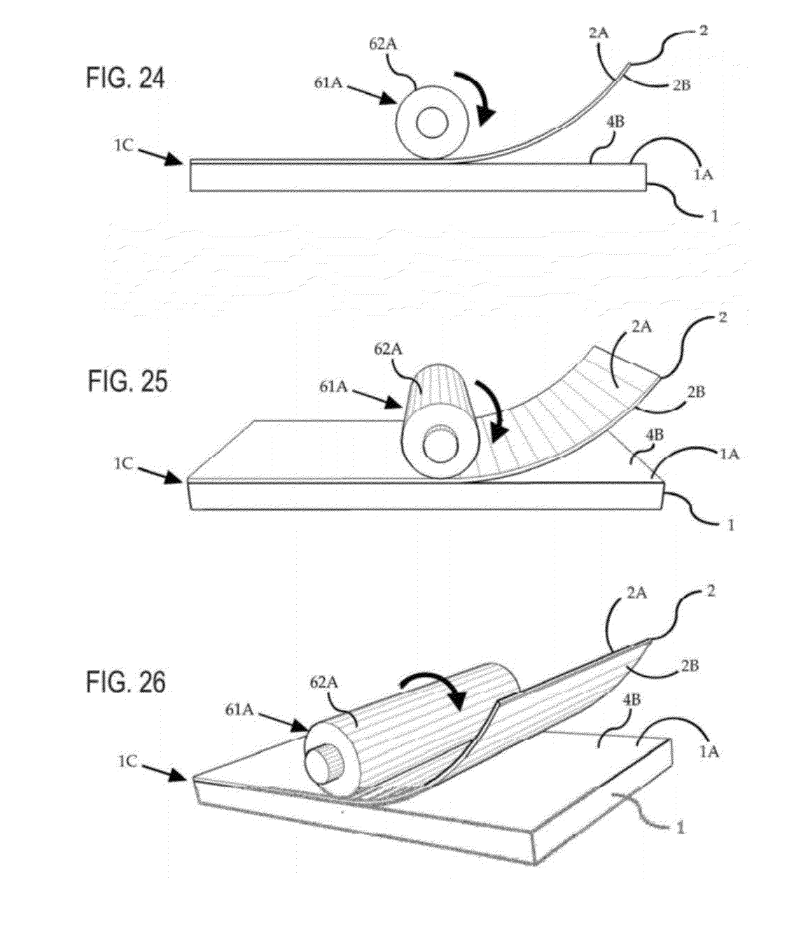

Following this alternative preliminary step, first carrier substrate 2 is bonded to or laminated over first side 1A of first resilient element 1 to form partial laminate 1C, as depicted in FIGS. 24, 25, and 26.

This is accomplished by pressing or heat pressing the assembled work piece as shown in FIGS. 24, 25, and 26, using first mechanical roller 61A, which may optionally incorporate first heated roller element 62A. It is understood that under this alternative and optional embodiment of the invention, first carrier substrate 2 will bond or adhere to first side 1A of first resilient element 1 to form partial laminate 1C, because second joining element 4B has been optionally placed or applied over first side 1A of first resilient element 1.

Partial laminate 1C (consisting of first resilient element 1 bonded or made to adhere to first carrier substrate 2 by means of second joining element 4B) is optionally positioned or placed adjacent to second resilient element 3, so that second side 3B of second resilient element 3 is facing first side 2A of first carrier substrate 2, in the manner depicted in FIGS. 27A-27C, 28, and 29, However, it is understood that in this alternative embodiment of the invention, first joining element 4A is optionally placed next to, or applied over, second side 3B of second resilient element 3, and not on first side 2A of first carrier substrate 2.

Partial laminate 1C is made to bond or adhere to second resilient element 3, by pressing or heat pressing the entire assembly, in the manner depicted in FIGS. 27A-27C, 28, and 29, by positioning first mechanical roller 61A adjacent to or against first side 3A of second resilient element 3, so that first mechanical roller 61A touches and optionally presses against the same. It is understood that if first joining element 4A is a hot-melt adhesive film or other bonding agent that is activated by heat, first mechanical roller 61A may optionally incorporate first heated roller element 62A.

It is understood that all alternative embodiments of the invention depicted in FIGS. 27A-27C, 28, and 29 and described in relation thereto may optionally be utilized to complete the bonding of second resilient element 3 to partial laminate 1C, forming first composite material 20. It is also understood that other types of composite materials (such as second composite material 25, third composite material 30, and fourth composite material 35) may be fabricated through the same or substantially similar process.

Second Alternative Method of Making Multi-Layered Composite with Resilient Elements Made of Different Types of Materials

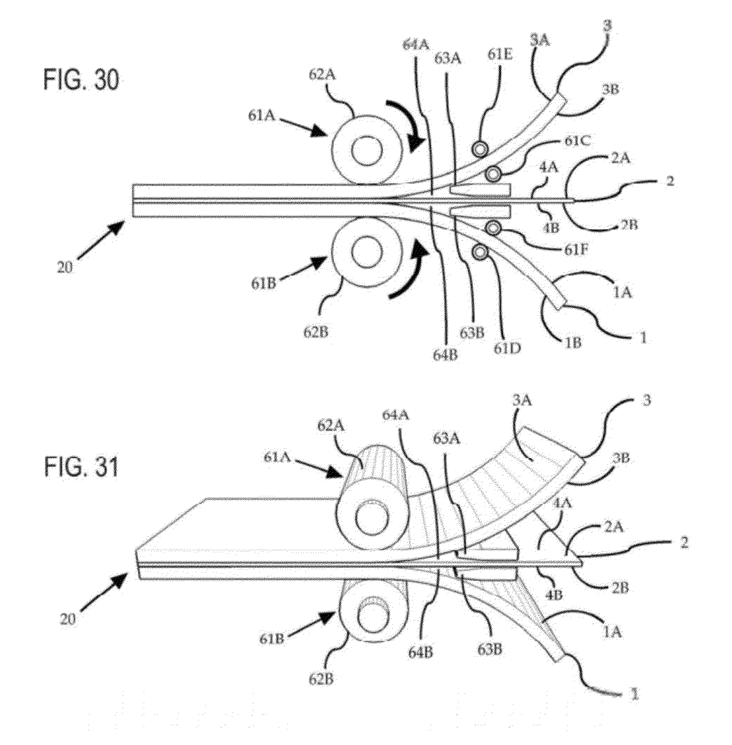

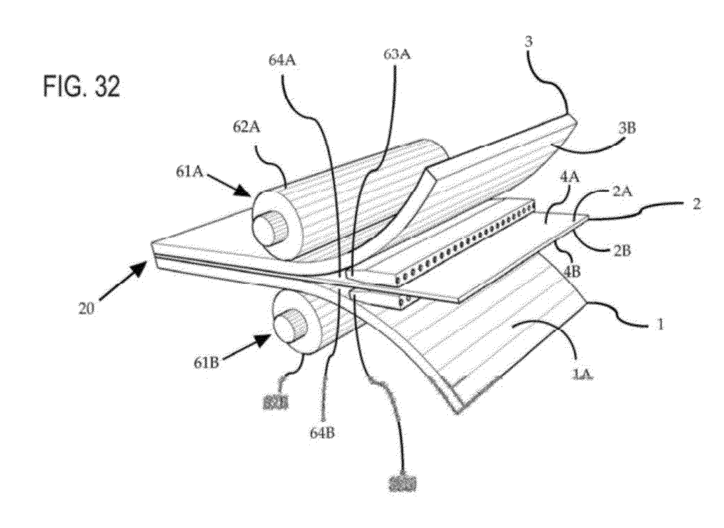

FIGS. 30 through 32 depict yet another optional method of manufacturing multi-layered composite materials, such as first composite material 20, second composite material 25, third composite material 30, and composite material 35.

As a preliminary step, second joining element 4B is placed next to, or applied over, second side 2B of first carrier substrate 2, and first joining element 4A is optionally placed next to, or applied over, first side 2A of first carrier substrate 2.

As depicted in FIGS. 30, 31, and 32, first carrier substrate 2 is bonded to first resilient element 1 and to second resilient element 3, as follows: First carrier substrate 2 is placed between first resilient element 1 and second resilient element 3. First carrier substrate 2 is positioned adjacent to or against first resilient element 1, so that first side 1A of first resilient element 1 faces second side 2B of first carrier substrate 2. First carrier substrate 2 is positioned adjacent to or against second resilient element 3, so that second side 3B of second resilient element 3 faces first side 2A of first carrier substrate 2.

It is understood that first joining element 4A is located between first side 2A of first carrier substrate 2 and second side 3B of second resilient element 3, and that second joining element 4B is located between second side 2B of first carrier substrate 2 and first side 1B of first resilient element 1, as depicted in FIG. 30.

As depicted in FIGS. 30, 31, and 32, first mechanical roller 61A is positioned adjacent to or against first side 3A of second resilient element 3, so that first mechanical roller 61A touches and optionally presses against the same. If first joining element 4A is a hot-melt adhesive film or other bonding agent that is activated by heat, first mechanical roller 61A may optionally incorporate first heated roller element 62A.

Second mechanical roller 61B may be positioned adjacent to or against second side 1B of first resilient element 1, so that second mechanical roller 61B touches and optionally presses against the same, as depicted in FIGS. 30, 31, and 32. Also, optionally, first mechanical roller 61B may incorporate second heated roller element 62B.

As depicted in FIGS. 30, 31, and 32, first heating element 63A is positioned between second resilient element 3 and first carrier substrate 2, and made to raise the temperature in first heating zone 64A, where second side 3B of second resilient element 3 is in relative proximity to the surface of first joining element 4A, which is positioned over first side 2A of first carrier substrate 2.

Optionally, second heating element 63B is positioned between first resilient element 1 and first carrier substrate 2, and made to raise the temperature in the second heating zone 64B, where first side 1A of first resilient element 1 is in relative proximity to the surface of second joining element 4B, which is positioned over second side 2B of first carrier substrate 2.

It is understood that first heating element 63A and second heating element 63B may each be optionally comprised of one or more gas heaters, electric heaters, infrared heaters, ultrasound or radio frequency heaters, or any other device, mechanism, or means of increasing the temperature at first heating zone 64A and second heating zone 64B. The heating elements (that is, first heating element 63A and second heating element 63B) must, individually or together, enable the temperature at the heating zones (that is, first heating zone 64A and second heating zone 64B) to rise to the point where first joining element 4A and second joining element 4B activate, liquefy, melt, cross-link, or bond with second resilient element 3 and first resilient element 1, respectively, or otherwise cause first carrier substrate 2 to bond or adhere to second resilient element 3, and cause first carrier substrate 2 to bond or adhere to first resilient element 1.

It is also understood that first heating element 63A and second heating element 63B may be placed or positioned in any locations that enable the temperature at first heating zone 64A and second heating zone 64B to rise to a point where first joining element 4A and second joining element 4B activate, liquefy, melt, cross-link, or otherwise cause first carrier substrate 2 to bond or adhere to second resilient element 3, and first carrier substrate 2 to bond or adhere to first resilient element 1, without damaging or degrading the other components, namely, first resilient element 1, first carrier substrate 2, and second resilient element 3.

In another embodiment of the invention, a single heating element may be used as an option (that is, either first heating element 63A or, in the alternative, second heating element 63B, and not both), provided that the single heating element can raise the temperature at both first heating zone 64A and second heating zone 64B to a point where both first joining element 4A and second joining element 4B activate, liquefy, melt, cross-link, or otherwise enable first carrier substrate 2 to bond or adhere to both second resilient element 3 and first resilient element 1.

As depicted in FIG. 30, in one embodiment of the invention, first mechanical roller 61A, second mechanical roller 61B, first heating element 63A, and second heating element 63B remain stationary. First mechanical roller 61A and second mechanical roller 61B are placed in relation to each other so that there is sufficient spacing between them (preferably and optionally equal to or less than the total combined thickness of first resilient element 1, first carrier substrate 2, first joining element 4A, second joining element 4B, and second resilient element 3 stacked together) to permit the arranged work piece (that is, the “stack” comprised of second resilient element 3, first joining element 4A, first carrier substrate 2, second joining element 4B, and first resilient element 1) to pass through the spacing, preferably and optionally in a compressed state.

As also depicted in FIG. 30, first mechanical roller 61A and second mechanical roller 61B rotate in opposite directions. In one embodiment of the invention, a “stack” comprised of second resilient element 3, first joining element 4A, first carrier substrate 2, second joining element 4B, and first resilient element 1 are inserted (“fed”) into the spacing between the two mechanical rollers, and the mechanical rollers compress the aforementioned arranged work piece. If one or more heated roller components (that is, first heated roller element 62A and second heated roller element 62B) are optionally present, the arranged work piece and its components are heat-compressed by the rollers.

Optionally, and alternatively, first mechanical roller 61A and second mechanical roller 61B may be mounted on a moving mechanism that enables first mechanical roller 61A and second mechanical roller 61B to travel across the surface of the arranged work piece while exerting pressure against it. It is understood that first heating element 63A and second heating element 63B may also be optionally mounted on a moving mechanism that enables first heating element 63A and second heating element 63B to travel along the length of the arranged work piece, while remaining static in relation to first mechanical roller 61A and second mechanical roller 61B.

In another embodiment of the invention, first mechanical roller 61A may optionally be mounted on a moving mechanism that enables first mechanical roller 61A to travel across the surface of the arranged work piece while exerting pressure against it. Likewise, second mechanical roller 61B may also be optionally mounted on a moving mechanism that enables second mechanical roller 61B to travel across the surface of the arranged work piece while exerting pressure against it. Optionally, first heating element 63A and second heating element 63B may also be mounted on a moving mechanism that enables the heating elements to travel along the length of the work piece.

In yet another embodiment of the invention, the arranged work piece may optionally be placed on a moving surface (such as a conveyer belt) or on a mechanism that permits the arranged work piece to travel in a direction compatible with the rotation of first mechanical roller 61A, while first mechanical roller 61A remains stationary as it rotates and exerts pressure against the work piece and compresses the same. Optionally, heating element 63 may remain stationary.

It is understood that during the pressing or heat-pressing operation, mechanical rollers, guides, holders, or other supporting devices, mechanisms, or means may optionally be utilized to support or guide first resilient element 1, second resilient element 3, and first carrier substrate 2. By way of example only, and without limitations, FIG. 30 depicts optional first supporting roller 61C, supporting or guiding second resilient element 3 in the course of the pressing or heat-pressing operation, and optional second supporting roller 61D, supporting or guiding first resilient element 1 in the course of the pressing or heat-pressing operation.

It is also understood that any number of additional rollers, guides, holders, or other supporting devices, mechanisms, or means may be optionally deployed and placed in a variety of optional and alternative locations to support or guide partial laminate 1C, first carrier substrate 2, and second resilient element 3 during the pressing or heat-pressing operation. By way of example only, and without limitations, FIG. 30 also depicts optional third supporting roller 61E, intended to further hold, support, guide, or stabilize second resilient element 3, and fourth supporting roller 61F, intended to further hold, support, guide, or stabilize first resilient element 1.

Upon completion of the pressing or heat-pressing operation, first carrier substrate 2 is bonded to first resilient element 1 and to second resilient element 3, forming first composite material 20. Other types of composite materials (such as second composite material 25, third composite material 30, and fourth composite material 35) may be fabricated through the same or substantially similar process.

As pointed out above, first composite material 20 is comprised of two layers of resilient elements bonded together in a sheeting structure, and joined by means of a carrier substrate. Preferably, although optionally, the two resilient elements in first composite material 20 are made of different types of materials.

However, it is understood that the alternative fabrication process described above may optionally be used to make composite materials comprised of at least two layers of resilient elements bonded together in a sheeting structure, in which at least two of the resilient elements are made of the same type of material, and are joined by means of a carrier substrate. By way of clarification, the same process described above may optionally be used to fabricate a variation of first composite material 20, wherein first resilient element 1 and second resilient element 3 are optionally comprised of the same type of material.

Manufacture of Multi-Layered Composite with Resilient Elements Made of the Same Type of Material

B2. Method of Making Multi-Layered Composite with Resilient Elements Made of the Same Type of Material

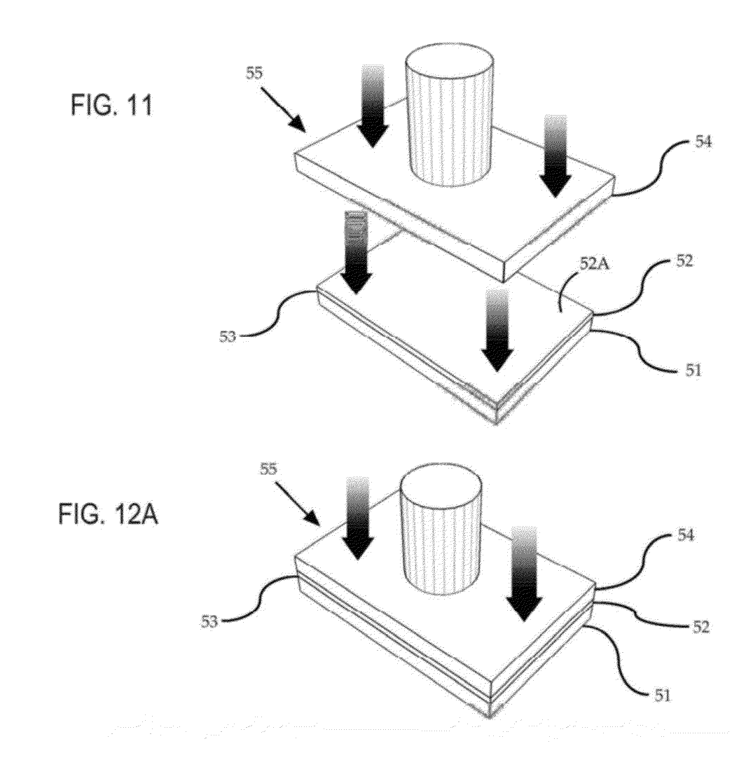

FIGS. 11, 12A, and 13 depict one optional method of manufacturing fifth composite material 36, shown in the exploded view in FIG. 9A and in FIG. 10A. Fifth composite material 36 is comprised of sixth resilient element 51, which is bonded or made to adhere to seventh resilient element 52 by means of fifth joining element 53.

As shown in FIG. 11, a mechanical press 55 is placed adjacent to the arranged work piece comprised of sixth resilient element 51, fifth joining element 53, and seventh resilient element 52, wherein fifth joining element 53 is positioned (or “sandwiched”) between sixth resilient element 51 and seventh resilient element 52. Alternatively, and optionally, fifth joining element 53 may be applied over the surface of first side 51A of sixth resilient element 51, or of second side 52B of seventh resilient element 52.

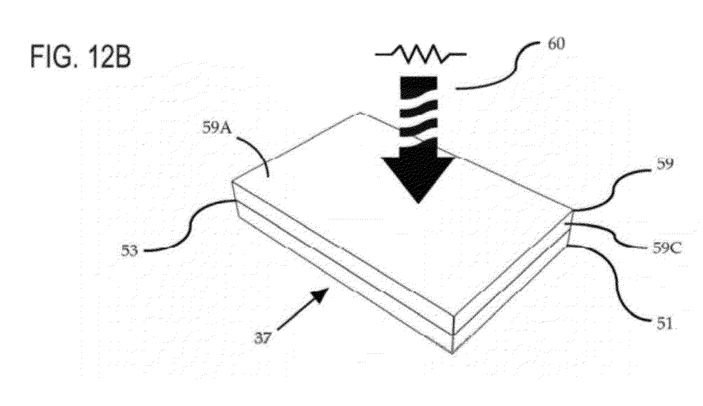

As shown in FIGS. 11 and 12, mechanical press 55 is positioned so that it makes contact with first side 52A of seventh resilient element 52, and the entire arranged work piece is compressed, so that each component of the work piece (that is, sixth resilient element 51, fifth joining element 53, and seventh resilient element 52) makes full contact with the other adjacent components and, optionally, is compressed against the same.

If fifth joining element 53 is a hot-melt adhesive (“HMA”) film or other bonding agent that is activated by heat, mechanical press 55 may incorporate a heated press element 54.

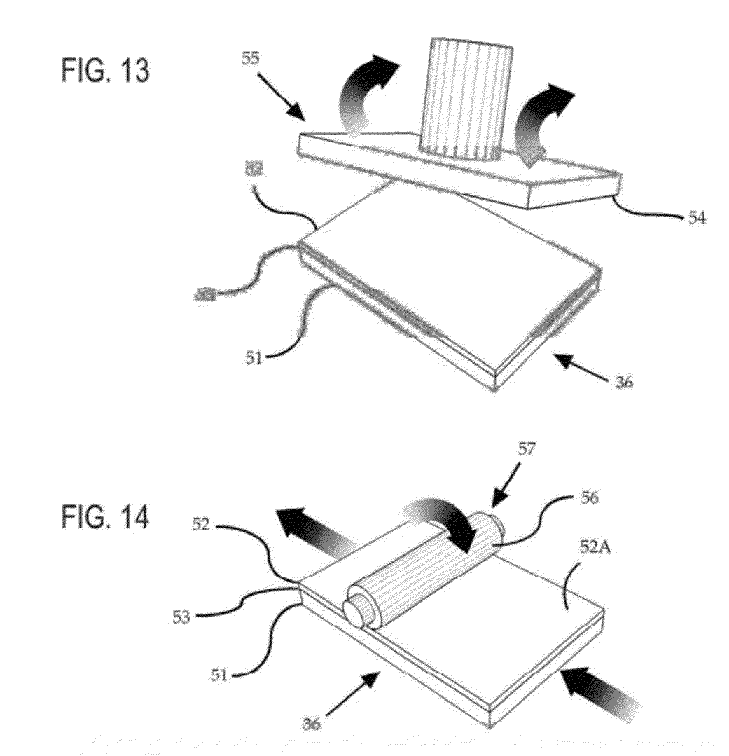

Following the pressing or heat-pressing operation, mechanical press 55 is withdrawn as depicted in FIG. 13, leaving sixth resilient element 51 bonded or made to adhere to seventh resilient element 52 by means of fifth joining element 53, thus resulting in fifth composite material 36.

In another embodiment of the invention, third mechanical roller 57 may optionally be used in lieu of mechanical press 55, wherein third mechanical roller 57 rotates and compresses the arranged work piece.

If fifth joining element 53 is a hot-melt adhesive (“HMA”) film or other bonding agent that is activated by heat, third mechanical roller 57 may incorporate third heated roller element 56. It is understood that third heated roller element 56 may be any device, mechanism, or means to heat the surface of third mechanical roller 57 as it touches or compresses seventh resilient element 52.

Also optionally, the surface of third mechanical roller 57 may incorporate or be coated with one or more non-reactive materials (such as silicone, polytetrafluoroethylene/PTFE, perfluoroalkoxy/PFA, fluorinated ethylene propylene/FEP, Teflon, or other similar non-reactive material) that do not adhere to the resilient elements or the joining elements.

Third mechanical roller 57 may optionally be mounted on a moving mechanism that enables third mechanical roller 57 to travel across the surface of the arranged work piece while compressing the entire assembly, so that each component (that is, sixth resilient element 51, fifth joining element 53, and seventh resilient element 52) makes full contact with the adjacent components and, optionally, is compressed against the same.

Alternatively, and optionally, the arranged work piece may also be placed on a moving surface (such as a conveyer belt) or a mechanism that permits the arranged work piece to travel in a direction compatible with the rotation of third mechanical roller 57, while third mechanical roller 57 remains stationary as it rotates and compresses the arranged work piece.

Alternative Method of Making Multi-Layered Composite with Resilient Elements Made of the Same Type of Material

As pointed out above, and as shown in FIGS. 11 through 14, if fifth joining element 53 is a hot-melt adhesive (“HMA”) film or other bonding agent that is activated by heat, mechanical press 55 or third mechanical roller 57 may incorporate a heating mechanism (such as heated press element 54 or third heated roller element 56) in order to activate the joining element.

However, as depicted by way of example in FIG. 12B, when heat source 60 (such as heated press element 54 or third heated roller element 56) is (a) optionally positioned over an arranged work piece such as sixth composite material 37, (b) comprised of sixth resilient element 51 that must be bonded or made to adhere to eighth resilient element 59 by means of fifth joining element 53 positioned between the resilient elements, and (c) eighth resilient element 59 is comprised of a relatively thick material that is not a good heat conductor, the mass of the resilient element located between heat source 60 and fifth joining element 53 may effectively but undesirably operate like a heat insulator, preventing the temperature of fifth joining element 53, or the area adjacent to the same, from rising to sufficient high levels to activate, liquefy, melt, cross-link, or otherwise enable fifth joining element 53 to bond or adhere to the resilient elements.

In some instances, depending on the composition and material thickness 59C of eighth resilient element 59, heat source 60 may cause the temperature of the surface of first side 59A and eighth resilient element 59 to reach unacceptably high levels before fifth joining element 53 can be heated up to its activation point. This could, in some instances, result of damage, degradation, undesirable deformation, or ignition of eighth resilient element 59 or sixth resilient element 51.

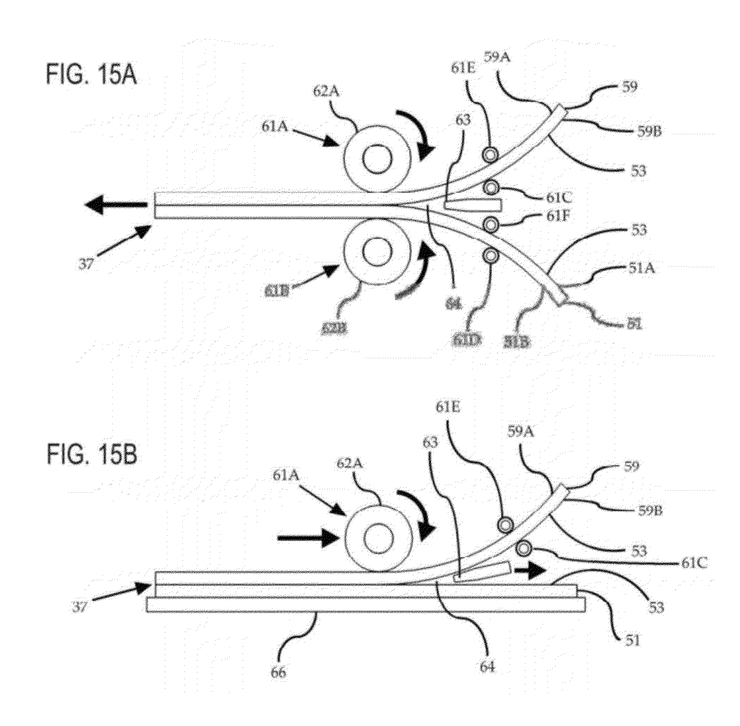

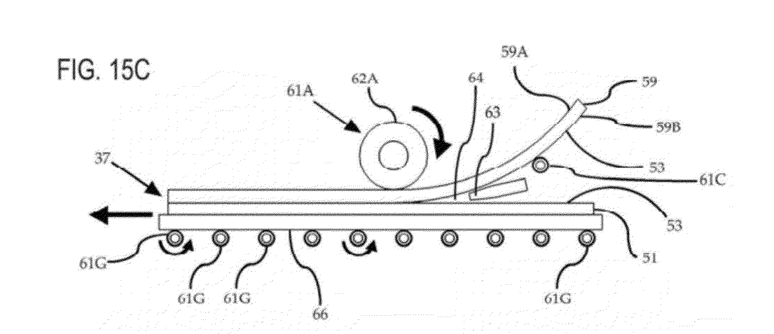

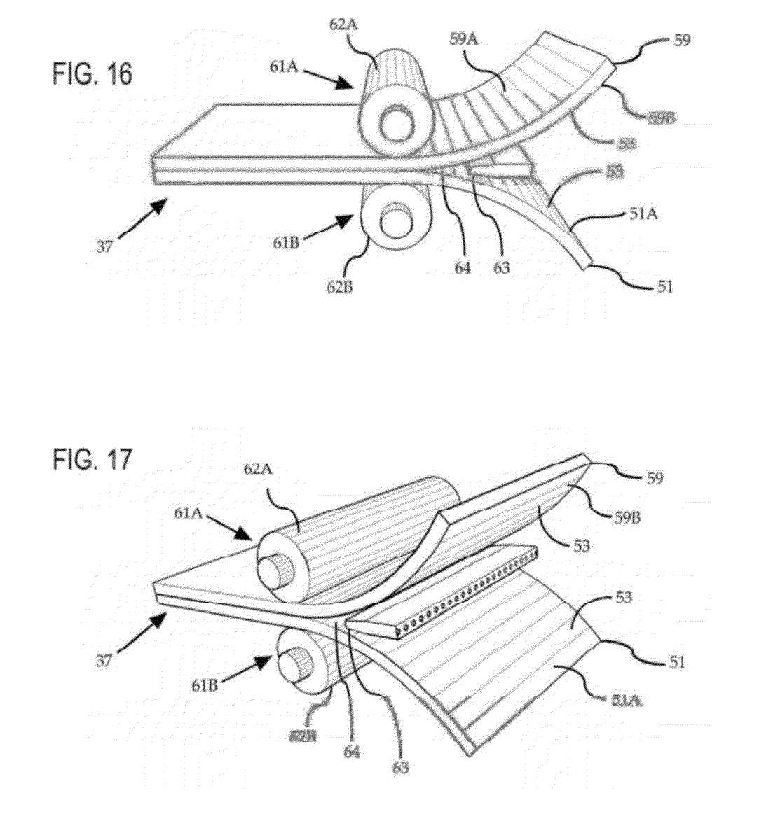

FIGS. 15A through 15C, and FIGS. 16 and 17, depict an alternative, optional method of manufacturing sixth composite material 37.

As a preliminary step, fifth joining element 53 is placed next to, or applied over, first side 51A of sixth resilient element 51. Alternatively, and optionally, fifth joining element 53 is placed next to, or applied over, second side 59B of eighth resilient element 59.

As shown in FIG. 15A, eighth resilient element 59 is positioned or placed adjacent to sixth resilient element 51, so that second side 59B of eighth resilient element 59 is facing first side 51A of sixth resilient element 51, and fifth joining element 53 is positioned (or “sandwiched”) between eighth resilient element 59 and sixth resilient element 51.

As depicted in FIGS. 15A-15C, 16, and 17, first mechanical roller 61A is positioned adjacent to or against first side 59A of eighth resilient element 59, so that first mechanical roller 61A touches and optionally presses against the same. If fifth joining element 53 is a hot-melt adhesive film or other bonding agent that is activated by heat, first mechanical roller 61A may optionally incorporate first heated roller element 62A.

Optionally, second mechanical roller 61B may be positioned adjacent to or against second side 51B of sixth resilient element 51, so that second mechanical roller 61B touches and optionally presses against the same, as depicted in FIGS. 15A, 16, and 17. Optionally, first mechanical roller 61B may also incorporate second heated roller element 62B.

As depicted in FIGS. 15A-15C, 16, and 17, heating element 63 is positioned between eighth resilient element 59 and sixth resilient element 51, and made to raise the temperature in heating zone 64, where the surface of second side 59B of eighth resilient element 59 is in relative proximity to the surface of first side 51A of sixth resilient element 51, and fifth joining element 53 is positioned between the two resilient elements.

As noted above, heating element 63 may optionally be comprised of one or more gas heaters, electric heaters, infrared heaters, ultrasound or radio frequency heaters, or any other device, mechanism, or means of increasing the temperature at heating zone 64. In this instance, heating element 63 must enable the temperature at the heating zone 64 to rise to the point where fifth joining element 53 activates, liquefies, melts, cross-links, or adheres to eighth resilient element 59 and to sixth resilient element 51, and bonds the two resilient elements.

It is understood that heating element 63 may be placed or positioned in any location that enables the temperature at heating zone 64 to rise to a point where fifth joining element 53 activates, liquefies, melts, cross-links, or otherwise causes sixth resilient element 51 to bond or adhere to eighth resilient element 59, without damaging, degrading, deforming, or igniting the components of the arranged work piece (that is, sixth resilient element 51 and eighth resilient element 59).

In one embodiment of the invention, sixth resilient element 51 is optionally comprised of material that is denser or has higher melting temperature than eighth resilient element 59, and heating element 63 is optionally positioned so that the heat generated by heating element 63 is directed primarily to the surface area of sixth resilient element 51 located within heating zone 64.

As depicted in FIG. 15A, in one embodiment of the invention, first mechanical roller 61A, second mechanical roller 61B, and heating element 63 remain stationary. First mechanical roller 61A and second mechanical roller 61B are placed in relation to each other so that there is sufficient spacing between them (preferably and optionally equal to or less than the total combined thickness of sixth resilient element 51, fifth joining element 53, and eighth resilient element 59 stacked together) to permit the arranged work piece to pass through the spacing, preferably and optionally in a compressed state.

As also depicted in FIG. 15A, first mechanical roller 61A and second mechanical roller 61B rotate in opposite directions. In one embodiment of the invention, eighth resilient element 59 and sixth resilient element 51 (and fifth joining element 53 “sandwiched” between them) are inserted (“fed”) into the spacing between the two mechanical rollers, and the mechanical rollers compress the components. If one or more heated roller components (that is, first heated roller element 62A and second heated roller element 62B) are optionally present, the components are heat-compressed by the rollers.

Optionally, and alternatively, first mechanical roller 61A may be mounted on a moving mechanism that enables first mechanical roller 61A to travel across the surface of the arranged work piece while exerting pressure against it. It is understood that second mechanical roller 61B may also be optionally mounted on a moving mechanism that enables second mechanical roller 61B to travel across the surface of the arranged work piece while exerting pressure against it.

In another embodiment of the invention, as depicted in FIG. 15B, sixth resilient element 51 may optionally be placed on a static work surface. First mechanical roller 61A and heating element 63 may optionally be mounted on a moving mechanism that enables first mechanical roller 61A to travel across the surface of the arranged work piece while exerting pressure against it. Optionally, heating element 63 may also be mounted on a moving mechanism that enables heating element 63 to travel along the length of the work piece.

In yet another embodiment of the invention, as depicted in FIG. 15C, the arranged work piece may optionally be placed on a moving surface 66 (such as, by way of example only and without limitations, a conveyer belt) or other mechanism (such as, by way of example only and without limitations, a plurality of fifth supporting rollers 61G) that permits the arranged work piece to travel in the direction compatible with the rotation of first mechanical roller 61A, while heating element 63 and first mechanical roller 61A remain stationary, and while first mechanical roller 61A rotates and exerts pressure against the work piece and compresses the same.

It is understood that during the pressing or heat-pressing operation, mechanical rollers, guides, holders, or other supporting devices, mechanisms, or means may optionally be utilized to support or guide sixth resilient element 51 and eighth resilient element 59. By way of example only, and without limitations, FIG. 15A depicts optional first supporting roller 61C, supporting or guiding eighth resilient element 59 in the course of the pressing or heat-pressing operation, and optional second supporting roller 61D, supporting or guiding sixth resilient element 51 in the course of the pressing or heat-pressing operation.

It is also understood that any number of rollers, guides, holders, or other supporting devices, mechanisms, or means may be optionally deployed and placed in a variety of optional and alternative locations to support or guide sixth resilient element 51 and eighth resilient element 59 during the pressing or heat-pressing operation. By way of example only, and without limitations, FIG. 15A, depicts optional third supporting roller 61E, intended to hold, support, or guide eighth resilient element 59, and fourth supporting roller 61F, intended to hold, support, or guide sixth resilient element 51.

Upon completion of the pressing or heat-pressing operation, eighth resilient element 59 is bonded to sixth resilient element 51, forming sixth composite material 37. However, it is understood that other types of composite materials (such as fifth composite material 36) may be fabricated through the same or substantially similar process.

Fifth composite material 36 and sixth composite material 37 are comprised of two layers of resilient elements bonded together in a sheeting structure, and bonded together by means of a joining element. Preferably, although optionally, the two resilient elements in fifth composite material 36 and sixth composite material 37 are made of the same type of material.

However, it is understood that the fabrication process described above may optionally be used to make composite materials comprised of at least two layers of resilient elements bonded together in a sheeting structure, in which at least two of the resilient elements are made of different types of materials, and are bonded together by means of a joining element, provided that the resilient elements are made of materials that are compatible and may be made to bond with the use of a single joining element, comprised of a glue, hot-melt adhesive (“HMA”) film, or other means of adhesion. By way of clarification, the same process described above may optionally be used to fabricate a variation of sixth composite material 37, wherein sixth resilient element 51 and eighth resilient element 59 are optionally comprised of different types of materials, provided that those materials may be suitably bonded by means of a single fifth joining element 53.

Those skilled in the art will recognize, or be able to ascertain using no more than routine experimentation, many equivalents to the specific embodiments of the invention specifically described herein. Such equivalents are intended to be encompassed in the scope of the claims.

What is claimed is:

1. A multi-layered composite pad comprising at least two layers of resilient element and at least one layer of carrier substrate, wherein at least one carrier substrate layer is positioned between two adjacent resilient elements, and the carrier substrate and resilient element are bound to each other through a joining element, wherein the joining element joins the carrier substrate and its adjacent resilient element.

2. The composite pad according to claim 1, wherein the resilient element layers are composed of material that are not capable of directly binding to each other.

3. The composite pad according to claim 2, comprising a carrier substrate having a first and second side is in contact with
a first joining element on a first side of the carrier substrate that allows binding between a first resilient element with the first side of the carrier substrate and
a second joining element on a second side of the carrier substrate that allows binding between a second resilient element with the second side of the carrier substrate.

4. The composite according to claim 3, wherein the first and second resilient elements are not capable of directly binding to each other.

5. The composite pad according to claim 1, comprising at least two layers of resilient element and at least two layers of carrier substrate.

6. The composite pad according to claim 5, comprising at least three layers of resilient element and at least two layers of carrier substrate.

7. The composite pad according to claim 6, comprising at least three layers of resilient element and at least three layers of carrier substrate.

8. The composite pad according to claim 7, comprising at least four layers of resilient element and at least three layers of carrier substrate.

9. The composite pad according to claim 8, comprising at least four layers of resilient element and at least four layers of carrier substrate.

10. The composite pad according to claim 1, wherein the carrier substrate is non-woven fabric, woven fabric, sheet of mesh, sheet of natural fiber, or sheet of synthetic fiber.

11. The composite pad according to claim 10, wherein the carrier substrate is composed of sheets or swatches of polyester or nylon fabric or mesh.

12. The composite pad according to claim 1, wherein the carrier substrate is one or more sheets or swatches of polyester or nylon fabric or mesh sheet, bonded to each other in one or more layers.

13. The composite pad according to claim 2, wherein the carrier substrate is one or more sheets or swatches of polyester or nylon fabric or mesh sheet, bonded to each other in one or more layers.

14. The composite pad according to claim 1, wherein the resilient element is made of ethylene vinyl acetate, olefin, or polyolefin foam, sheet, or film, polyurethane foam, sheet, or film, or urethane based foam, sheet, or film.

15. The composite pad according to claim 2, wherein the resilient element is made of ethylene vinyl acetate, olefin, or polyolefin foam, sheet, or film, polyurethane foam, sheet, or film, or urethane based foam, sheet, or film.

16. The composite pad according to claim 4, wherein the first resilient element is made of a composition comprising ethylene vinyl acetate, olefin, or polyolefin foam, sheet, or film.

17. The composite pad according to claim 4, wherein the second resilient element is made of a composition comprising polyurethane foam, sheet, or film, or urethane based foam, sheet, or film.

18. The composite pad according to claim 1, wherein the joining element is an adhesive capable of joining the carrier substrate to the adjoining resilient element.

19. The composite pad according to claim 2, wherein the joining element is an adhesive capable of joining the carrier substrate to the adjoining resilient element.

20. The composite pad according to claim 3, wherein the joining element is an adhesive capable of joining the carrier substrate to the adjoining resilient element.

21. The composite pad according to claim 4, wherein the joining element is an adhesive capable of joining the carrier substrate to the adjoining resilient element.

22. The composite pad according to claim 18, wherein the adhesive is made of a composition comprising ethylene vinyl acetate, olefin, or polyolefin based glue, hot-melt adhesive film, or bonding agent, or polyurethane or urethane based glue or hot-melt adhesive film, or bonding agent.

23. The composite pad according to claim 18, wherein the adhesive is a double-sided tape with adhesive coated on both sides.

24. The composite pad according to claim 3, wherein the first joining element is made of a composition comprising ethylene vinyl acetate, olefin, or polyolefin based glue, hot-melt adhesive film, or bonding agent.

25. The composite pad according to claim 3, wherein the second joining element is made of a composition comprising polyurethane or urethane based glue or hot-melt adhesive film, or bonding agent.

26. The composite pad according to claim 1, wherein the resilient element or carrier substrate is perforated.

27. The composite pad according to claim 1, wherein the resilient elements are same or different in physical characteristics.

28. The composite pad according to claim 1, wherein the resilient elements and carrier substrate layers are positioned in alternating order.

29. A solid support comprising the composite according to claim 1.

30. The support according to claim 29, which is an athletic garment, footwear, bag, backpack, sack, seating pads, or athletic equipment.

31. An athletic safety wear, comprising the composite according to claim 1.

32. A method for fabricating a multi-layered composite structure for use as a resilient cushion, comprising:
(i) applying or positioning first adhesive on first side of first carrier substrate or first side of first resilient element;
(ii) contacting first side of first resilient element with the first side of the carrier substrate through contact with the first adhesive;
(iii) applying pressure or heat or both to the first carrier substrate or the first resilient element to form a first laminate;
(iv) applying or positioning second adhesive on second side of first carrier substrate, the first side of second resilient element, or to both the first carrier substrate and the first resilient element;
(v) contacting first side of second resilient element with second side of first carrier substrate through contact with the second adhesive; and
(vi) applying pressure or heat or both to the first carrier substrate or the second resilient element to form second laminate.

33. The method according to claim 32, further comprising:
(vii) applying or positioning third adhesive on first side of second carrier substrate or second side of second resilient element;
(viii) contacting second side of second resilient element with the second carrier substrate through contact with the third adhesive; and
(ix) applying pressure or heat or both to the second carrier substrate or second resilient element to form third laminate.

34. The method according to claim 33, further comprising:
(x) applying or positioning fourth adhesive on second side of second carrier substrate or first side of third resilient element;
(xi) contacting first side of third resilient element with the second side of the second carrier substrate through contact with the fourth adhesive; and
(xii) applying pressure or heat or both to the second carrier substrate or third resilient element to form fourth laminate.

35. The method according to claim 32, wherein the resilient elements are same or different in physical characteristics.

36. The method according to claim 32, wherein the first adhesive or second adhesive comprises a double-sided tape with adhesive coated on both sides.

37. The method according to claim 32, wherein the first adhesive is made of a composition comprising ethylene vinyl acetate, olefin, or polyolefin based glue, hot-melt adhesive film, or bonding agent.

38. The method according to claim 32, wherein the second adhesive is made of a composition comprising polyurethane or urethane based glue or hot-melt adhesive film, or bonding agent.

39. The method according to claim 32, wherein the first resilient element is made of a composition comprising ethylene vinyl acetate, olefin, or polyolefin foam, sheet, or film.

40. The method according to claim 32, wherein the second resilient element is made of a composition comprising polyurethane foam, sheet, or film, or urethane based foam, sheet, or film.

41. The method according to claim 32, wherein the heat or pressure or both is applied through a roller.

42. The method according to claim 32, wherein the heat or pressure or both is applied simultaneously to each side of the laminate.

43. The method according to claim 32, wherein heat is provided separately from the pressure.

44. The method according to claim 32, wherein the surface of the carrier substrate or the resilient elements to be bonded to each other, or both surfaces, is/are pre-heated by way of a heating element prior to the application of heat, pressure, or both.
